(19) United States
(12) Patent Application Publication
(10) Pub. No.: US 2025/0214299 A1
(43) Pub. Date: Jul. 3, 2025

(54) THREE-DIMENSIONAL PRINTING

(71) Applicants: Peridot Print LLC, Palo Alto, CA (US); Nanyang Technological University, Singapore (SG)

(72) Inventors: Wei Shian TEY, Singapore (SG); Xiaojiang LIU, Singapore (SG); Kun ZHOU, Singapore (SG)

(21) Appl. No.: 18/861,131

(22) PCT Filed: Apr. 29, 2022
(86) PCT No.: PCT/US2022/027133

§ 371 Date: Oct. 28, 2024

(51) Int. Cl. B29C 64/165; B29C 64/264; B29K 77/00; B29K 509/08; B33Y 10/00; B33Y 70/10

(52) U.S. Cl. CPC B29C 64/165; B29C 64/264; B29K 2077/00; B29K 2509/08; B29K 2995/0094; B33Y 10/00; B33Y 70/10

(57) ABSTRACT

A three-dimensional (3D) printing build material composition includes polyamide-12 particles, solid glass beads, and glass fibers having an average aspect ratio ranging from about 12:1 to about 20:1 and an average length ranging from about 200 pm to less than 300 pm. The polyamide-12 particles are present in an amount of at least 55 wt % based on a total weight of the build material composition. The solid glass beads are present in an amount ranging from about 5 wt % to less than 15 wt % based on the total weight of the build material composition. The glass fibers are present in an amount ranging from about 15 wt % to about 25 wt % based on the total weight of the build material composition.

### BACKGROUND

Three-dimensional (3D) printing is an additive manufacturing process used to make three-dimensional solid parts from a digital model. 3D printing techniques are considered additive manufacturing processes because they involve the application of successive layers of material (which, in some examples, may include build material, binder and/or other printing liquid(s), or combinations thereof). This is unlike traditional machining processes, which often rely upon the removal of material to create the final part. 3D printing is often used in rapid product prototyping, mold generation, mold master generation, and short run manufacturing for mass personalization and customization of goods.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic diagram illustrating an example 3D printing technique;

FIG. 2 is a schematic diagram illustrating another example 3D printing technique;

FIG. 3 is a schematic, cross-sectional view, taken in the Y-Z plane, of an example of a 3D printed object printed from the bottom to the top on a build area platform having an X-Y plane;

FIG. 4 is a schematic, cross-sectional view, taken in the Y-Z plane, of another example of a 3D printed object printed from the bottom to the top on a build area platform having an X-Y plane;

FIG. 5 is a graph depicting the weight percentage (%, Y axis) versus the temperature (° C., X axis) for different example tensile bar specimens (Ex. 1=20 wt % glass fibers and 5 wt % glass beads; Ex. 2=20 wt % glass fibers and 10 wt % glass beads; Ex. 3=20 wt % glass fibers and 15 wt % glass beads; and Ex. 4=20 wt % glass fibers and 20 wt % glass beads) and a comparative example tensile bar specimen (Comp. Ex. A=20 wt % glass fibers and no glass beads);

FIG. 6A is a graph depicting the tensile strength (MPa, Y axis) versus the glass bead (GB) weight fraction (%, X axis) present in the different example tensile bar specimens and the comparative example tensile bar specimen in each of the X, Y, and Z orientations;

FIG. 6B is a graph depicting the tensile modulus (GPa, Y axis) versus the glass bead (GB) weight fraction (%, X axis) present in the different example tensile bar specimens and the comparative example tensile bar specimen in each of the X, Y, and Z orientations;

FIG. 6C is a graph depicting the elongation at break (%, Y axis) versus the glass bead (GB) weight fraction (%, X axis) present in the different example tensile bar specimens and the comparative example tensile bar specimen in each of the X, Y, and Z orientations;

FIG. 7 is a graph depicting the stress (MPa, Y axis) versus the strain (%, X axis) for one of the example tensile bar specimens (Ex. 2=20 wt % glass fibers and 10 wt % glass beads) in each of the X, Y, and Z orientations;

FIG. 8A through FIG. 8D are MicroCT images of each of the example tensile bar specimens (Ex. 1=FIG. 8A, Ex. 2=FIG. 8B, Ex. 3=FIG. 8C, and Ex. 4=FIG. 8D);

FIG. 9 is a graph depicting tensile strength (MPa, Y axis) versus the elongation at break (%, X axis) for one of the example tensile bar specimens (Ex. 1=20 wt % glass fibers and 5 wt % glass beads) in each of the X, Y, and Z orientations; and

FIG. 10 is a graph depicting the average tensile modulus (GPa, Y axis) versus the average ultimate tensile strength (MPa, X axis) for different example tensile bar specimens (Ex. 1=20 wt % glass fibers and 5 wt % glass beads and Ex. 2=20 wt % glass fibers and 10 wt % glass beads) and comparative specimens.

### DETAILED DESCRIPTION

The three-dimensional (3D) printing techniques disclosed herein utilize a build material composition that includes a combination of polyamide-12 particles, solid glass beads, and glass fibers. The specific sizes and amounts of the glass beads and glass fibers have been found to reduce or eliminate the shrinkage exhibited by the 3D object and to reduce the porosity of the formed 3D object. The specific sizes and amounts of the glass beads and glass fibers have also been found to significantly increase the mechanical properties of the formed 3D object, in particular in transverse loading directions (e.g., in the X and Z orientations), compared to 3D printed objects formed with neat polyamide-12 particles and/or comparative compositions that include polyamide-12 particles and glass beads or glass fibers. Additionally, the specific sizes and amounts of the glass beads and glass fibers do not deleteriously affect the flowability and spreadability of the build material composition.

Throughout this disclosure, a weight percentage that is referred to as “wt % active” refers to the loading of an active component of stock formulation that is present, e.g., in a fusing agent, detailing agent, etc. For example, an energy absorber, such as carbon black, may be present in a water-based formulation (e.g., a stock solution or dispersion) before being incorporated into the fusing agent vehicle. In this example, the wt % active of the carbon black accounts for the loading (as a weight percent) of the carbon black solids that are present in the fusing agent, and does not account for the weight of the other components (e.g., water, etc.) that are present in the stock solution or dispersion with the carbon black. The term “wt %,” without the term actives, refers to the loading of a 100% active component that does not include other non-active components therein.

### Build Material Composition

The three-dimensional (3D) printing build material composition includes polyamide-12 particles present in an amount of at least 55 wt % based on a total weight of the build material composition, solid glass beads present in an amount ranging from about 5 wt % to less than 15 wt % based on the total weight of the build material composition, and glass fibers having an average aspect ratio ranging from about 12:1 to about 20:1 and an average length ranging from about 200 μm to less than 300 μm, the glass fibers being present in an amount ranging from about 15 wt % to about 25 wt % based on the total weight of the build material composition.

The polyamide-12 (also known as nylon 12) particles in the build material composition may be in the form of a powder. The polyamide-12 particles may be made up of similarly sized particles and/or differently sized particles. In an example, the average particle size of the polyamide-12 particles ranges from about 20 μm to about 220 μm. As used herein, the term “average particle size” refers to the average diameter of the particles. In an example, the polyamide-12 particle distribution (D10 to D90) ranges from about 30 μm to about 125 μm with a median diameter of about 60 μm (D50). The average particle size may be determined using dynamic light scattering or tunable resistive pulse sensing.

The polyamide-12 particles are present in the build material composition in an amount of at least 55 wt % based on the total weight of the build material composition. In some instances, the build material composition consists of the polyamide-12 particles, the glass beads, and the glass fibers, and thus the amount of the polyamide-12 particles depends upon the amount of the glass beads and the glass fibers. In other instances, the build material composition consists of the polyamide-12 particles, the glass beads, the glass fibers, and one or more of the additives set forth herein, and thus the amount of the polyamide-12 particles depends upon the amount of the glass beads, the glass fibers, and the additive(s). In one example, the polyamide-12 particles are present in an amount ranging from about 60 wt % to about 75 wt % based on the total weight of the build material composition. In other examples, the polyamide-12 particles make up from about 65 wt % to about 70 wt % of the build material composition.

The build material composition includes two types of filler material, namely glass beads and glass fibers. In the examples disclosed herein, the build material composition is free of other filler materials, such as carbon fibers, carbon nanotubes, aluminum fibers, graphene nanoplatelets, etc.

The glass of the glass beads and/or the glass fibers is selected from the group consisting of soda lime glass (Na₂O/CaO/SiO₂), borosilicate glass, phosphate glass, fused quartz, and a combination thereof. In another example, the glass of the glass beads and/or the glass fibers is selected from the group consisting of soda lime glass, borosilicate glass, and a combination thereof. In yet other examples, the glass of the glass beads and/or the glass fibers may be any type of non-crystalline silicate glass. The silanized surface may provide the glass fibers with higher reactivity,

In some examples, a surface of the glass fibers has a silanized surface. More specifically, the glass fiber surface may be modified with a functional group selected from the group consisting of an acrylate functional silane, a methacrylate functional silane, an epoxy functional silane, an ester functional silane, an amino functional silane, and a combination thereof. Examples of glass modified with such functional groups and/or such functional groups that may be used to modify the glass are available from Potters Industries, LLC (e.g., an epoxy functional silane or an amino functional silane), Gelest, Inc. (e.g., an acrylate functional silane or a methacrylate functional silane), Sigma-Aldrich (e.g., an ester functional silane), etc. Silanized glass fibers may be more reactive with the polyamide-12 particles, which may enable stronger interactions and lead to reduced porosity.

The glass beads are solid glass beads. The solid glass beads have a particle size ranging from about 20 μm to about 35 μm. In one example, the average particle size of the solid glass beads in 30 μm.

The glass beads are present in the build material composition in an amount ranging from about 5 wt % to less than 15 wt % based on the total weight of the build material composition. When the glass fibers are present in an amount of about 20 wt %, the glass beads may be present in an amount ranging from about 5 wt % to about 10 wt %, based on the total weight of the build material composition. At these glass bead and glass fiber percentages, desirable values for ultimate tensile strength, tensile modulus, and elongation at break may be achieved. When lower amounts of the glass fibers (within the provided range) are used, higher amounts of the glass beads (within the provided range) may be used.

The glass fibers have an average aspect ratio (i.e., average length/average width or diameter) ranging from about 12:1 to about 20:1, and an average length ranging from about 200 μm to less than 300 μm. It has been found that when the average length is below 200 μm, the mechanical properties are deleteriously affected, and when the average length is above 300 μm, the flowability and spreadability of the build material composition is deleteriously affected. Thus, the average length of the glass fibers is within the given range, and the average width may be selected so that the average aspect ratio is within the given range. In one example, the average length of the glass fibers ranges from about 200 μm to about 250 μm; and the average width of the glass fibers ranges from about 12 μm to about 16 μm. In one specific example, the average length of the glass fibers is about 226 μm, the average width is about 16 μm, and the average aspect ratio is about 14:1.

The glass fibers, with an average aspect ratio within the provided range, become oriented along the spreading direction, which results in directionally reinforced three-dimensional objects. Similar reinforcement may not be achieved with neat polyamide-12 particles or with composites that include, for example, glass beads alone.

The glass fibers are present in the build material composition in an amount ranging from about 15 wt % to about 25 wt % based on the total weight of the build material composition. When lower amounts (e.g., 10 wt %) of the glass fibers are used, the resulting 3D printed object lacks reinforcement, and when higher amounts (e.g., 30 wt %) are used, the resulting 3D printed object has undesirable porosity.

In some examples, in addition to the polyamide-12 particles, the glass beads, and the glass fibers, the build material composition may include a flow aid, an antioxidant, an antistatic agent, or a combination thereof. While several examples of these additives are provided, it is to be understood that these additives are selected to be thermally stable (i.e., will not decompose) at the 3D printing temperatures.

Flow aid(s) may be added to improve the coating flowability of the build material composition. Flow aids may be particularly beneficial when the polyamide-12 particles in the build material composition have an average particle size less than 25 μm. The flow aid improves the flowability of the build material composition by reducing the friction, the lateral drag, and the tribocharge buildup (by increasing the particle conductivity). In one example, the flow aid is silica (SiO₂), e.g., hydrophobic fumed silica nanoparticles. Other examples of suitable flow aids include tricalcium phosphate (E341), powdered cellulose (E460(ii)), magnesium stearate (E470b), sodium bicarbonate (E500), sodium ferrocyanide (E535), potassium ferrocyanide (E536), calcium ferrocyanide (E538), bone phosphate (E542), sodium silicate (E550), calcium silicate (E552), magnesium trisilicate (E553a), talcum powder (E553b), sodium aluminosilicate (E554), potassium aluminum silicate (E555), calcium aluminosilicate (E556), bentonite (E558), aluminum silicate (E559), stearic acid (E570), and polydimethylsiloxane (E900). In an example, the flow aid is present in an amount up to 0.2 wt % based on the total weight of the build material composition. As such, when included, the flow aid may range from greater than 0 wt % to 0.2 wt %, based upon the total weight of the build material composition. The flow aid may be in the form of fine particles (e.g., having a specific surface area ranging from about 100 m²/g to about 300 m²/g) that are dry blended with the polyamide-12 particles, the glass beads, and the glass fibers.

Antioxidant(s) may be added to the build material composition to prevent thermal degradation of the polyamide-12 particles and/or to further prevent or slow discoloration (e.g., yellowing) of the composition by preventing or slowing oxidation of the polyamide-12 particles. In some examples, the antioxidant may be a radical scavenger. In these examples, the antioxidant may include IRGANOX® 1098 (benzenepropanamide, N,N′-1,6-hexanediylbis(3,5-bis(1,1-dimethylethyl)-4-hydroxy)), IRGANOX® 254 (a mixture of 40% triethylene glycol bis(3-tert-butyl-4-hydroxy-5-methylphenyl), polyvinyl alcohol and deionized water), and/or other sterically hindered phenols. In other examples, the antioxidant may include a phosphite and/or an organic sulfide (e.g., a thioester). In an example, the antioxidant may be included in the build material composition in an amount ranging from about 0.01 wt % to about 5 wt %, based on the total weight of the build material composition. In other examples, the antioxidant may be included in the build material composition in an amount ranging from about 0.01 wt % to about 2 wt % or from about 0.2 wt % to about 1 wt % or from about 0.1 wt % to about 0.3 wt %, based on the total weight of the build material composition. The antioxidant may be in the form of fine particles (e.g., having an average particle size of 5 μm or less, e.g., 3 μm, 1.5 μm, etc.) that are dry blended with the polyamide-12 particles, the glass beads, and the glass fibers. Some antioxidants may be ground to reduce the particle size before being blended with the polyamide-12 particles, the glass beads, and the glass fibers.

Antistatic agent(s) may be added to the build material composition to suppress tribo-charging. Examples of suitable antistatic agents include aliphatic amines (which may be ethoxylated), aliphatic amides, quaternary ammonium salts (e.g., behentrimonium chloride or cocamidopropyl betaine), esters of phosphoric acid, polyethylene glycolesters, or polyols. Some suitable commercially available antistatic agents include HOSTASTAT® FA 38 (natural based ethoxylated alkylamine), HOSTASTAT® FE2 (fatty acid ester), and HOSTASTAT® HS 1 (alkane sulfonate), each of which is available from Clariant Int. Ltd.). In an example, the antistatic agent is added in an amount ranging from greater than 0 wt % to less than 1 wt %, based upon the total weight of the build material composition. The antistatic agent may be introduced during manufacturing or compounded into the polyamide-12 particles during processing.

The build material composition disclosed herein may be prepared by physical powder mixing the polyamide-12 particles with the glass beads and the glass fibers (alone or in combination with one or more of the other additives disclosed herein), and sieving the mixture. The mixing process may be a dry or wet mixing process. It is to be understood that the glass fibers (before being mixed with the polyamide-12 particles) or the mixture of the polyamide-12 particles, the glass beads, and the glass fibers are not exposed to a grinding process that could alter the average aspect ratio of the glass fibers.

### Fusing Agents

The build material composition disclosed herein may be used in an additive manufacturing method that uses one or more fusing agents to pattern the build material composition in a layer by layer fashion. This manufacturing method involves the selective application of the fusing agent(s) to pattern a layer of the build material composition, and exposure of the entire patterned layer to electromagnetic radiation. In this method, the patterned region (which, in some instances, is less than the entire layer) of the build material composition coalesces and solidifies to become a layer of a 3D object. A variety of fusing agents may be used in this technique, each of which includes an energy absorber. In some examples, the energy absorber exhibits absorption at least at some wavelengths within a range of from 100 nm to 4000 nm. Unless stated other, the term “absorption” means that 80% or more of the applied radiation having wavelengths within the specified range is absorbed by the energy absorber. Also unless stated otherwise, the term “transparency” means that 25% or less of the applied radiation having wavelengths within the specified range is absorbed by the energy absorber.

Several example fusing agents will now be described.

### Fusing Agent #1

One example of the fusing agent (fusing agent #1) is referred to herein as a core fusing agent, and the energy absorber in the core fusing agent has absorption at least at wavelengths ranging from 400 nm to 780 nm (e.g., in the visible region). The energy absorber in the core fusing agent may also absorb energy in the infrared region (e.g., 800 nm to 4000 nm). During 3D printing, the absorption of the energy absorber generates heat suitable for coalescing/fusing the build material composition in contact therewith, which leads to 3D printed polyamide objects having mechanical integrity and relatively uniform mechanical properties (e.g., strength, elongation at break, etc.). This absorption, however, also results in strongly colored, e.g., dark grey or black, 3D printed objects (or 3D printed object regions).

Examples of the energy absorber in the core fusing agent may be an infrared light absorbing colorant. In an example, the energy absorber is a near-infrared light absorbing colorant. Any near-infrared colorants, e.g., those produced by Fabricolor, Eastman Kodak, or BASF, Yamamoto, may be used in the core fusing agent. As one example, the core fusing agent may be a printing liquid formulation including carbon black as the energy absorber. Examples of this printing liquid formulation are commercially known as CM997A, 516458, C18928, C93848, C93808, or the like, all of which are available from HP Inc.

As another example, the core fusing agent may be a printing liquid formulation including near-infrared absorbing dyes as the active material. Examples of this printing liquid formulation are described in U.S. Pat. No. 9,133,344, incorporated herein by reference in its entirety. Some examples of the near-infrared absorbing dye are water-soluble near-infrared absorbing dyes selected from the group consisting of:

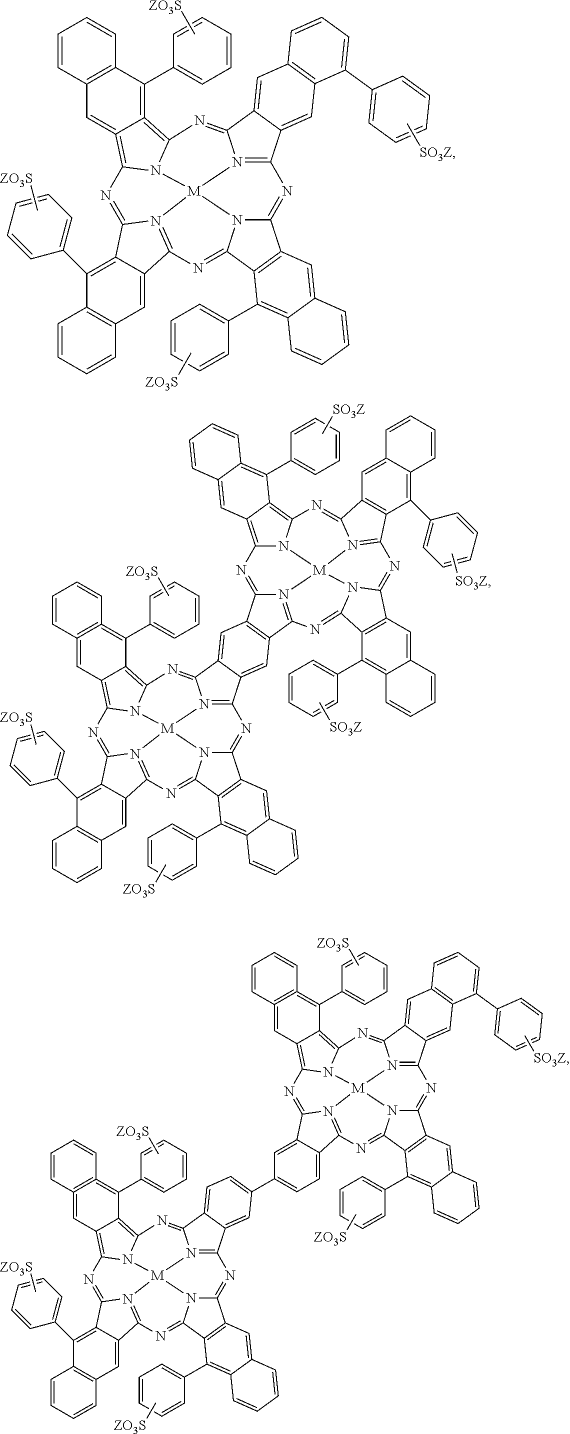

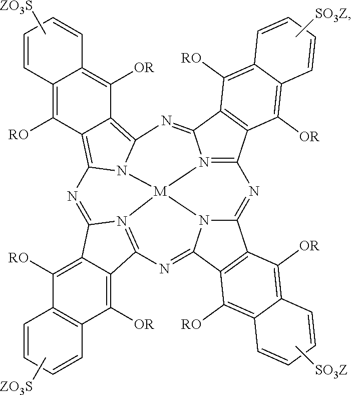

and mixtures thereof. In the above formulations, M can be a divalent metal atom (e.g., copper, etc.) or can have OSO₃Na axial groups filling any unfilled valencies if the metal is more than divalent (e.g., indium, etc.), R can be hydrogen or any C₁-C₈ alkyl group (including substituted alkyl and unsubstituted alkyl), and Z can be a counterion such that the overall charge of the near-infrared absorbing dye is neutral. For example, the counterion can be sodium, lithium, potassium, NH₄⁺, etc.

Some other examples of the near-infrared absorbing dye are hydrophobic near-infrared absorbing dyes selected from the group consisting of:

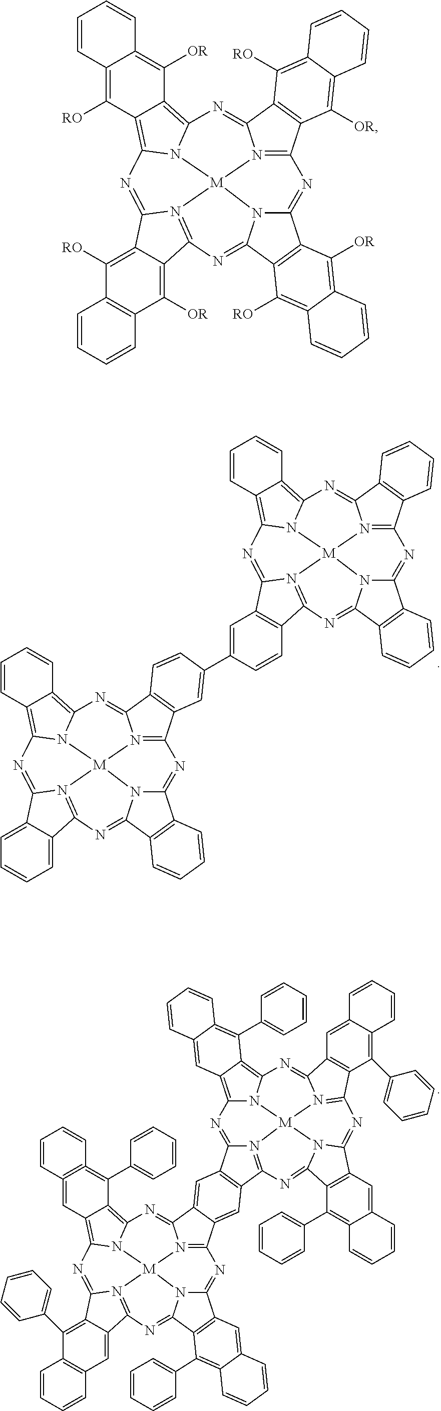

and mixtures thereof. For the hydrophobic near-infrared absorbing dyes, M can be a divalent metal atom (e.g., copper, etc.) or can include a metal that has Cl, Br, or OR′ (R′═H, CH₃, COCH₃, COCH₂COOCH₃, COCH₂COCH₃) axial groups filling any unfilled valencies if the metal is more than divalent, and R can be hydrogen or any C₁-C₈ alkyl group (including substituted alkyl and unsubstituted alkyl).

Other near-infrared absorbing dyes or pigments may be used in the core fusing agent. Some examples include anthraquinone dyes or pigments, metal dithiolene dyes or pigments, cyanine dyes or pigments, perylenediimide dyes or pigments, croconium dyes or pigments, pyrilium or thiopyrilium dyes or pigments, boron-dipyrromethene dyes or pigments, or aza-boron-dipyrromethene dyes or pigments.

Anthraquinone dyes or pigments and metal (e.g., nickel) dithiolene dyes or pigments may have the following structures, respectively:

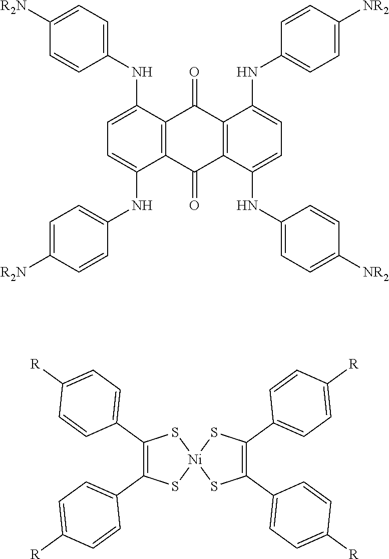

where R in the anthraquinone dyes or pigments may be hydrogen or any C₁-C₈ alkyl group (including substituted alkyl and unsubstituted alkyl), and R in the dithiolene may be hydrogen, COOH, SO₃, NH₂, any C₁-C₈ alkyl group (including substituted alkyl and unsubstituted alkyl), or the like.

Cyanine dyes or pigments and perylenediimide dyes or pigments may have the following structures, respectively:

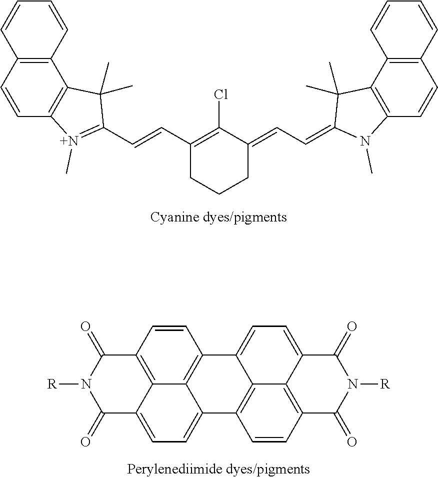

where R in the perylenediimide dyes or pigments may be hydrogen or any C₁-C₈ alkyl group (including substituted alkyl and unsubstituted alkyl).

Croconium dyes or pigments and pyrilium or thiopyrilium dyes or pigments may have the following structures, respectively:

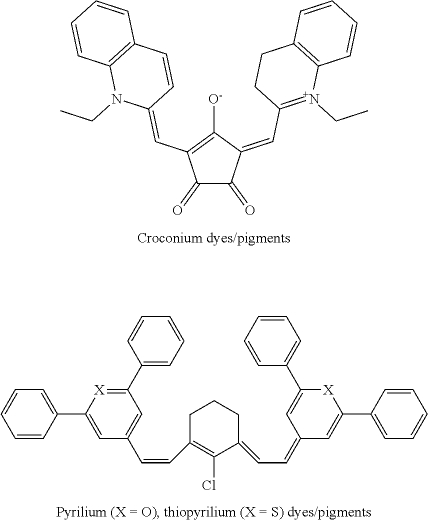

Boron-dipyrromethene dyes or pigments and aza-boron-dipyrromethene dyes or pigments may have the following structures, respectively:

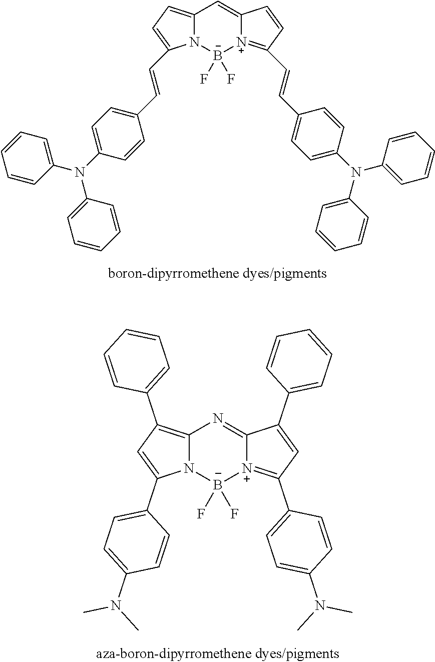

Other suitable near-infrared absorbing dyes may include aminium dyes, tetraaryldiamine dyes, phthalocyanine dyes, and others.

Other near infrared absorbing materials include conjugated polymers (i.e., a polymer that has a backbone with alternating double and single bonds), such as poly(3,4-ethylenedioxythiophene)-poly(styrenesulfonate) (PEDOT:PSS), a polythiophene, poly(p-phenylene sulfide), a polyaniline, a poly(pyrrole), a poly(acetylene), poly(p-phenylene vinylene), polyparaphenylene, or combinations thereof.

The amount of the energy absorber that is present in the core fusing agent ranges from greater than 0 wt % active to about 40 wt % active based on the total weight of the core fusing agent. In other examples, the amount of the active material in the core fusing agent ranges from about 0.3 wt % active to 30 wt % active, from about 1 wt % active to about 20 wt % active, from about 1.0 wt % active up to about 10.0 wt % active, or from greater than 4.0 wt % active up to about 15.0 wt % active. It is believed that these active material loadings provide a balance between the core fusing agent having jetting reliability and heat and/or radiation absorbance efficiency.

### Fusing Agent #2

Another example of the fusing agent (fusing agent #2) is referred to herein as a primer fusing agent or a low tint fusing agent, and the energy absorber in the primer fusing agent is a plasmonic resonance absorber having absorption at wavelengths ranging from 100 nm to 400 nm or 800 nm to 4000 nm and having transparency at wavelengths ranging from 400 nm to 780 nm. This absorption and transparency allow the primer fusing agent to absorb enough radiation to coalesce/fuse the build material composition in contact therewith, while enabling the 3D printed polyamide objects (or 3D printed regions) to be white or slightly colored.

Some examples of the primer fusing agent are dispersions including the energy absorber that has absorption at wavelengths ranging from 800 nm to 4000 nm and transparency at wavelengths ranging from 400 nm to 780 nm. The absorption of this energy absorber may be the result of plasmonic resonance effects. Electrons associated with the atoms of the energy absorber may be collectively excited by radiation, which results in collective oscillation of the electrons. The wavelengths that can excite and oscillate these electrons collectively are dependent on the number of electrons present in the energy absorber particles, which in turn is dependent on the size of the energy absorber particles. The amount of energy that can collectively oscillate the particle's electrons is low enough that very small particles (e.g., 1 nm to 100 nm) may absorb radiation with wavelengths several times (e.g., from 8 to 800 or more times) the size of the particles. The use of these particles allows the primer fusing agent to be inkjet jettable as well as electromagnetically selective (e.g., having absorption at wavelengths ranging from 800 nm to 4000 nm and transparency at wavelengths ranging from 400 nm to 780 nm).

In an example, the energy absorber of the primer fusing agent has an average particle size (e.g., volume-weighted mean diameter) ranging from greater than 0 nm to less than 220 nm. In another example, the energy absorber has an average particle size ranging from greater than 0 nm to 120 nm. In a still another example, the energy absorber has an average particle size ranging from about 10 nm to about 200 nm.

In an example, the energy absorber of the primer fusing agent is an inorganic pigment. Examples of suitable inorganic pigments include lanthanum hexaboride (LaB₆), tungsten bronzes (AxWO₃), indium tin oxide (In₂O₃:SnO₂, ITO), antimony tin oxide (Sb₂O₃:SnO₂, ATO), titanium nitride (TiN), aluminum zinc oxide (AZO), ruthenium oxide (RuO₂), iron pyroxenes (AₓFe_{y}Si₂O₆ wherein A is Ca or Mg, x=1.5-1.9, and y=0.1-0.5), modified iron phosphates (AₓFe_{y}PO₄), modified copper phosphates (AₓCu_{y}PO_{z}), and modified copper pyrophosphates (AₓCu_{y}P₂O₇). Tungsten bronzes may be alkali doped tungsten oxides. Examples of suitable alkali dopants (i.e., A in AₓWO₃) may be cesium, sodium, potassium, or rubidium. In an example, the alkali doped tungsten oxide may be doped in an amount ranging from greater than 0 mol % to about 0.33 mol % based on the total mol % of the alkali doped tungsten oxide. Suitable modified iron phosphates (AₓFe_{y}PO) may include copper iron phosphate (A=Cu, x=0.1-0.5, and y=0.5-0.9), magnesium iron phosphate (A=Mg, x=0.1-0.5, and y=0.5-0.9), and zinc iron phosphate (A=Zn, x=0.1-0.5, and y=0.5-0.9). For the modified iron phosphates, it is to be understood that the number of phosphates may change based on the charge balance with the cations. Suitable modified copper pyrophosphates (AₓCu_{y}P₂O₇) include iron copper pyrophosphate (A=Fe, x=0-2, and y=0-2), magnesium copper pyrophosphate (A=Mg, x=0-2, and y=0-2), and zinc copper pyrophosphate (A=Zn, x=0-2, and y=0-2). Combinations of the inorganic pigments may also be used.

The amount of the energy absorber that is present in the primer fusing agent ranges from greater than 0 wt % active to about 40 wt % active based on the total weight of the primer fusing agent. In other examples, the amount of the energy absorber in the primer fusing agent ranges from about 0.3 wt % active to 30 wt % active, from about 1 wt % active to about 20 wt % active, from about 1.0 wt % active up to about 10.0 wt % active, or from greater than 4.0 wt % active up to about 15.0 wt % active. It is believed that these energy absorber loadings provide a balance between the primer fusing agent having jetting reliability and heat and/or radiation absorbance efficiency.

The energy absorber of the primer fusing agent may, in some instances, be dispersed with a dispersant. As such, the dispersant helps to uniformly distribute the energy absorber throughout the primer fusing agent. Examples of suitable dispersants include polymer or small molecule dispersants, charged groups attached to the energy absorber surface, or other suitable dispersants. Some specific examples of suitable dispersants include a water-soluble acrylic acid polymer (e.g., CARBOSPERSE® K7028 available from Lubrizol), water-soluble styrene-acrylic acid copolymers/resins (e.g., JONCRYL® 296, JONCRYL® 671, JONCRYL® 678, JONCRYL® 680, JONCRYL® 683, JONCRYL® 690, etc. available from BASF Corp.), a high molecular weight block copolymer with pigment affinic groups (e.g., DISPERBYK®-190 available BYK Additives and Instruments), or water-soluble styrene-maleic anhydride copolymers/resins.

Whether a single dispersant is used or a combination of dispersants is used, the total amount of dispersant(s) in the primer fusing agent may range from about 10 wt % to about 200 wt % based on the weight of the energy absorber in the primer fusing agent.

A silane coupling agent may also be added to the primer fusing agent to help bond the organic (e.g., dispersant) and inorganic (e.g., pigment) materials. Examples of suitable silane coupling agents include the SILQUEST® A series manufactured by Momentive.

Whether a single silane coupling agent is used or a combination of silane coupling agents is used, the total amount of silane coupling agent(s) in the primer fusing agent may range from about 0.1 wt % active to about 50 wt % active based on the weight of the energy absorber in the primer fusing agent. In an example, the total amount of silane coupling agent(s) in the primer fusing agent ranges from about 1 wt % active to about 30 wt % active based on the weight of the energy absorber. In another example, the total amount of silane coupling agent(s) in the primer fusing agent ranges from about 2.5 wt % active to about 25 wt % active based on the weight of the energy absorber.

One example of the primer fusing agent includes cesium tungsten oxide (CTO) nanoparticles as the energy absorber. The CTO nanoparticles have a formula of CsₓWO₃, where 0<x<1. The cesium tungsten oxide nanoparticles may give the primer fusing agent a light blue color. The strength of the color may depend, at least in part, on the amount of the CTO nanoparticles in the primer fusing agent. When it is desirable to form an outer white layer on the 3D printed polyamide object, less of the CTO nanoparticles may be used in the primer fusing agent in order to achieve the white color. In an example, the CTO nanoparticles may be present in the primer fusing agent in an amount ranging from about 1 wt % active to about 20 wt % active (based on the total weight of the primer fusing agent).

The average particle size of the CTO nanoparticles may range from about 1 nm to about 40 nm. In some examples, the average particle size of the CTO nanoparticles may range from about 1 nm to about 15 nm or from about 1 nm to about 10 nm. The upper end of the particle size range (e.g., from about 30 nm to about 40 nm) may be less desirable, as these particles may be more difficult to stabilize.

This example of the primer fusing agent may also include a zwitterionic stabilizer. The zwitterionic stabilizer may improve the stabilization of this example of the primer fusing agent. While the zwitterionic stabilizer has an overall neutral charge, at least one area of the molecule has a positive charge (e.g., amino groups) and at least one other area of the molecule has a negative charge. The CTO nanoparticles may have a slight negative charge. The zwitterionic stabilizer molecules may orient around the slightly negative CTO nanoparticles with the positive area of the zwitterionic stabilizer molecules closest to the CTO nanoparticles and the negative area of the zwitterionic stabilizer molecules furthest away from the CTO nanoparticles. Then, the negative charge of the negative area of the zwitterionic stabilizer molecules may repel CTO nanoparticles from each other. The zwitterionic stabilizer molecules may form a protective layer around the CTO nanoparticles, and prevent them from coming into direct contact with each other and/or increase the distance between the particle surfaces (e.g., by a distance ranging from about 1 nm to about 2 nm). Thus, the zwitterionic stabilizer may prevent the CTO nanoparticles from agglomerating and/or settling in the primer fusing agent.

Examples of suitable zwitterionic stabilizers include C₂ to C₈ betaines, C₂ to C₈ aminocarboxylic acids having a solubility of at least 10 g in 100 g of water, taurine, and combinations thereof. Examples of the C₂ to C₈ aminocarboxylic acids include beta-alanine, gamma-aminobutyric acid, glycine, and combinations thereof.

The zwitterionic stabilizer may be present in the primer fusing agent in an amount ranging from about 2 wt % active to about 35 wt % active (based on the total weight of the primer fusing agent). When the zwitterionic stabilizer is the C₂ to C₈ betaine, the C₂ to C₈ betaine may be present in an amount ranging from about 8 wt % to about 35 wt % active of the total weight of the primer fusing agent. When the zwitterionic stabilizer is the C₂ to C₈ aminocarboxylic acid, the C₂ to C₈ aminocarboxylic acid may be present in an amount ranging from about 2 wt % active to about 20 wt % active of the total weight of the primer fusing agent. When the zwitterionic stabilizer is taurine, taurine may be present in an amount ranging from about 2 wt % active to about 35 wt % active of the total weight of the primer fusing agent.

In this example, the weight ratio of the CTO nanoparticles to the zwitterionic stabilizer may range from 1:10 to 10:1; or the weight ratio of the CTO nanoparticles to the zwitterionic stabilizer may be 1:1.

### Fusing Agent #3

Still another example of the fusing agent (fusing agent #3) is referred to herein as an ultraviolet (UV) light fusing agent, and the energy absorber in the UV fusing agent is a molecule or compound having absorption at wavelengths ranging from 100 nm to 400 nm. These energy absorbers efficiently absorb the UV radiation, convert the absorbed UV radiation to thermal energy, and promote the transfer of the thermal heat to build material composition in order to coalesce the build material composition.

The UV fusing agent can be used with a narrow-band emission source, such as UV light emitting diodes (LEDs), which reduces the band of photon energies to which the non-patterned build material is exposed and thus potentially absorbs. This can lead to more accurate object shapes and reduced rough edges. Some UV energy absorbers are substantially colorless and thus can generate much lighter (e.g., white, off-white, or even translucent) 3D objects than infrared (IR) and/or visible radiation absorbers.

Some examples of UV energy absorbers suitable for the UV fusing agent include a B vitamin and/or a B vitamin derivative. Any B vitamins and/or B vitamin derivatives that are water soluble and that have absorption at wavelengths ranging from about 340 nm to about 415 nm may be used in the UV light fusing agent. As used herein, the phrase “that has absorption at wavelengths ranging from about 340 nm to about 415 nm” means that the B vitamin or B vitamin derivative exhibits maximum absorption at a wavelength within the given range and/or has an absorbance of about 0.1 (about 80% transmittance or less) at one or more wavelengths within the given range. Some of the B vitamins or B vitamin derivatives have lower absorbance. These B vitamins or B vitamin derivatives can still result in suitable coalescence and fusing when they are coupled with a higher intensity and/or a higher dose (where dose=intensity*radiation time).

Examples of suitable B vitamins include riboflavin (vitamin B2), pantothenic acid (vitamin B5), pyridoxine (one form of vitamin B6), pyridoxamine (another form of vitamin B6), biotin (vitamin B7), folic acid (synthetic form of vitamin B9), cyanocobalamin (synthetic form of vitamin B12), and combinations thereof. Examples of suitable B vitamin derivatives include flavin mononucleotide, pyridoxal phosphate hydrate, pyridoxal hydrochloride, pyridoxine hydrochloride, and combinations thereof. Any combination of one or more B vitamins and one or more B vitamin derivatives may also be used. This may be desirable, for example, when one vitamin or vitamin derivative is less absorbing.

The amount of the B vitamin and/or B vitamin derivative present in the UV light fusing agent will depend, in part, upon its solubility in water and its effect on the jettability of the fusing agent. When solubility limit of the B vitamin and/or B vitamin derivative is low, the B vitamin and/or B vitamin derivative may be present in an amount ranging from about 1 wt % active to about 5 wt % active of the total weight of the fusing agent. For example, when the B vitamin or the B vitamin derivative is selected from the group consisting of riboflavin (solubility in water 1000 mg/3,000-15,000 mL depending on the crystal structure), folic acid (solubility in water 0.01 mg/mL), cyanocobalamin (solubility in water 1000 mg/80 mL), panthotenic acid (solubility in water 2110 mg/mL), biotin (solubility in water 0.22 mg/mL), pyridoxine (solubility in water ranging from 79 mg/mL to 220 mg/mL), and combinations thereof, the B vitamin or the B vitamin derivative is present in an amount ranging from about 1 wt % active to about 5 wt % active based on a total weight of the UV light fusing agent. When solubility limit of the B vitamin and/or B vitamin derivative is higher, the B vitamin and/or B vitamin derivative may be present in an amount ranging from about 1 wt % active to about 8 wt % active of the total weight of the fusing agent. For example, when the B vitamin or the B vitamin derivative is selected from the group consisting pyridoxal phosphate hydrate (solubility in water 5.7 mg/mL), pyridoxal hydrochloride (solubility in water 11.7 mg/mL), pyridoxine hydrochloride (solubility in water 200 mg/mL), pyridoxamine (solubility in water 29 mg/mL), and combinations thereof, the B vitamin or the B vitamin derivative may be present in an amount ranging from about 1 wt % active to about 8 wt % active based on a total weight of the UV light fusing agent.

Another example of UV energy absorber is a functionalized benzophenone. Some of the functionalized benzophenones have absorption at wavelengths ranging from about 340 nm to 405 nm. The phrase “have absorption at wavelengths ranging from about 340 nm to about 405 nm” means that the functionalized benzophenone exhibits maximum absorption at a wavelength within the given range and/or has an absorbance of about 0.1 (about 80% transmittance or less) at one or more wavelengths within the given range.

The functionalized benzophenone is benzophenone substituted with at least one hydrophilic functional group. The functionalization may render the substituted benzophenone more hydrophilic than benzophenone and/or may shift the absorption of the substituted benzophenone to the desired UV range (340 nm to 405 nm). As such, the functionalized benzophenone is a benzophenone derivative including at least one hydrophilic functional group. In some examples, the functionalized benzophenone is benzophenone substituted with one hydrophilic functional group. In other examples, the functionalized benzophenone is benzophenone substituted with two hydrophilic functional groups. In still other examples, the functionalized benzophenone is benzophenone substituted with three hydrophilic functional groups. In the examples where the benzophenone is substituted with multiple functional groups, these groups may be the same or different. Examples of the hydrophilic functional group may be selected from the group consisting of an amine group, a hydroxy group, an alkoxy group, a carboxylic acid group, or a sulfonic acid group.

In examples where the at least one hydrophilic functional group is the amine group, the functionalized benzophenone is selected from the group consisting of

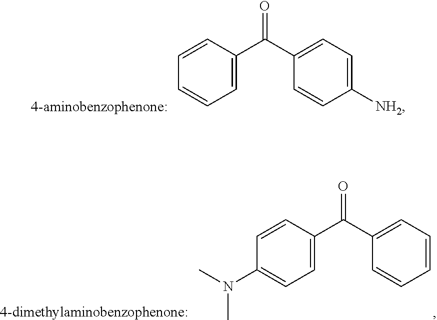 [SMILES: Nc1ccc(C(=O)c2ccccc2)cc1 ; "4-aminobenzophenone:" ; "4-dimethylaminobenzophenone:" ; CN(C)c1ccc(C(=O)c2ccccc2)cc1 ; ","]

and combinations thereof.

In examples where the at least one hydrophilic functional group is the hydroxy group, the functionalized benzophenone is selected from the group consisting are

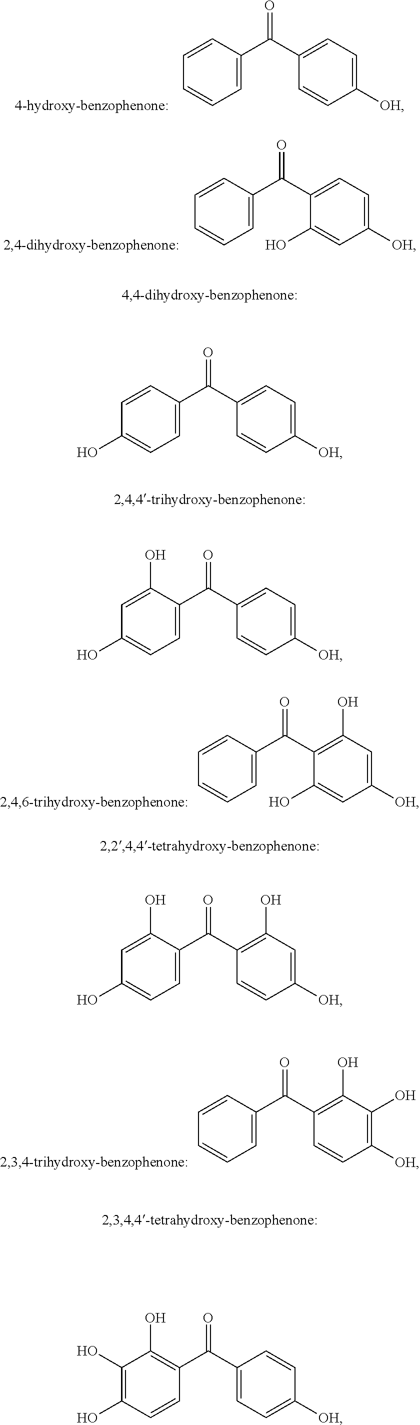

and combinations thereof.

In examples where the at least one hydrophilic functional group is the alkoxy group, the functionalized benzophenone is 4,4′-dimethoxybenophenone:

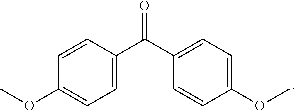

In other examples, the functionalized benzophenone may contain hydrophilic functional groups that are different. In these examples, the functionalized benzophenone is a benzophenone derivative including at least two different hydrophilic functional groups.

In one example, a first hydrophilic functional group of the at least two different hydrophilic functional groups is an alkoxy group, and a second hydrophilic functional group of the at least two different hydrophilic functional groups is a hydroxyl group. Some examples of these functionalized benzophenones include

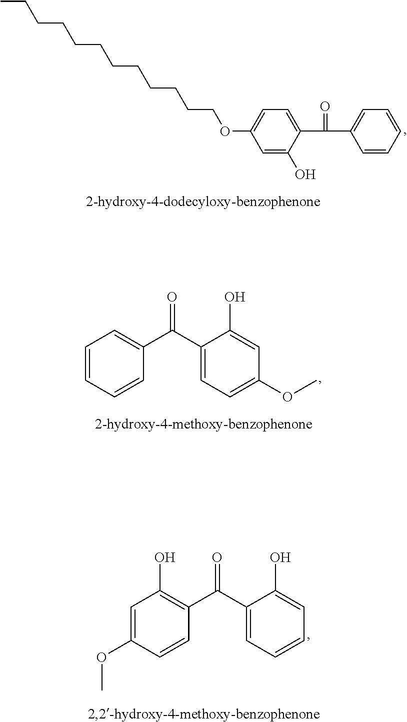 [SMILES: CCCCCCCCCCCCOc1ccc(C(=O)c2ccccc2)c(O)c1 ; COc1ccc(C(=O)c2ccccc2)c(O)c1 ; COc1ccc(C(=O)c2ccccc2O)c(O)c1]

and combinations thereof.

In another example, a first hydrophilic functional group of the at least two different hydrophilic functional groups may be selected from the group consisting of a hydroxy group and a carboxylic acid group, and a second hydrophilic functional group of the at least two different hydrophilic functional groups is an alkyl group. Some examples of these functionalized benzophenones include

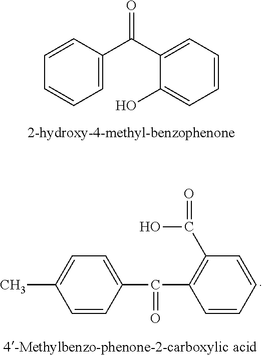 [SMILES: O=C(c1ccccc1)c1ccccc1O ; Cc1ccc(C(=O)c2ccccc2C(=O)O)cc1]

In yet another example, a first hydrophilic functional group of the at least two different hydrophilic functional groups is a hydroxy group, a second hydrophilic functional group of the at least two different hydrophilic functional groups is an alkoxy group, and a third hydrophilic functional group of the at least two different hydrophilic functional groups is a sulfonic acid group. An example of this functionalized benzophenone is 2-hydroxy-4-methoxy-benzophenone-5-sulfonic acid.

Examples of the functionalized benzophenones include 4-hydroxy-benzophenone, 2,4-dihydroxy-benzophenone, 4,4 dihydroxy-benzophenone, 2,4,4′-trihydroxy-benzophenone, 2,4,6 trihydroxy-benzophenone, 2,2′,4,4′-tetrahydroxy-benzophenone, 4,4′-dimethoxybenzophenone, 4-aminobenzophenone, 4-dimethylamino-benzophenone, 2-hydroxy-4-methyl-benzophenone, 4′-methylbenzo-phenone-2-carboxylic acid, 2-hydroxy-4-dodecyloxy-benzophenone, 2-hydroxy-4-methoxy-benzophenone, 2-hydroxy-4-methoxy-benzophenone-5-sulfonic acid, 2,3,4-trihydroxy-benzophenone, 2,3,4,4′-tetrahydroxy-benzophenone, 2,2′-hydroxy-4-methoxy-benzophenone, and combinations thereof.

While several examples of functionalized benzophenones have been provided herein, it is to be understood that any benzophenone substituted with at least one hydrophilic functional group may be used. These may be naturally occurring or synthesized. As examples, benzophenone derivatives with at least one poly(ethylene glycol) (PEG) chain or with at least one phosphocholine chain may be synthesized.

The functionalized benzophenone is at least partially soluble in an aqueous vehicle of the fusing agent. The phrase “at least partially soluble” means that at least 0.5 wt % of the functionalized benzophenone is able to dissolve in the aqueous vehicle.

The amount of the functionalized benzophenone present in the UV light fusing agent will depend, in part, upon its solubility in the aqueous vehicle and its effect on the jettability of the fusing agent. The functionalized benzophenone may be present in an amount ranging from about 0.01 wt % active to about 10 wt % active of the total weight of the fusing agent. When the solubility limit of the functionalized benzophenone in the aqueous vehicle is low (e.g., is less than 5 wt % soluble), the functionalized benzophenone may be present in an amount ranging from about 0.01 wt % active to about 5 wt % active of the total weight of the fusing agent. In an example, the functionalized benzophenone may be present in an amount ranging from about 2 wt % active to about 4 wt % active of the total weight of the fusing agent.

Still another example of UV energy absorber is a plasmonic metal nanoparticle that i) provides absorption enhancement at radiation wavelengths ranging from about 340 nm to about 450 nm, and ii) is present in an amount up to 2 wt % active based on a total weight of the UV light fusing agent.

In an example, the plasmonic metal nanoparticle is selected from the group consisting of silver nanoparticles, gold nanoparticles, copper nanoparticles, aluminum nanoparticles, and combinations thereof. The example plasmonic metal nanoparticles do not merely absorb the UV in the selected range, they exhibit enhanced absorption caused by localized surface plasmon resonance in the near UV and the high photon energy end of visible range (range 340-450 nm). The phrase “absorbs radiation at wavelengths ranging from about 340 nm to about 450 nm” means that the plasmonic metal nanoparticle exhibits maximum absorption at a wavelength within the given range and/or has an absorbance greater than 1 (about 10% transmittance or less) at one or more wavelengths within the given range.

The plasmonic metal nanoparticle may have an average particle size ranging from about 1 nm to about 200 nm. In one example, the plasmonic metal nanoparticle has an average particle size ranging from about 1 nm to about 100 nm. In another example, the plasmonic metal nanoparticle has an average particle size ranging from about 1 nm to about 50 nm.

Yet another example of a suitable UV energy absorber is a fluorescent yellow dye having a targeted wavelength of maximum absorption for a 3D print system including the narrow UV-band emission source. The UV light absorber consists of the fluorescent yellow dye, without any other colorant. In particular, it would not be desirable to include any pigment or dye that absorbs other light, or any pigment that could crash out of solution when included with the fluorescent yellow dye.

The fluorescent yellow dye may be pyranine:

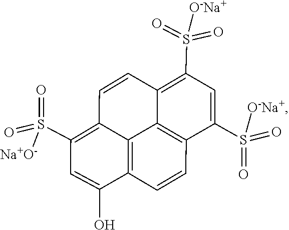

a pyranine derivative, coumarin:

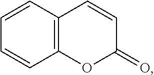 [SMILES: O=c1ccc2ccccc2o1]

a coumarin derivative, a naphthalimide:

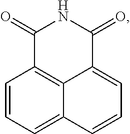 [SMILES: O=C1NC(=O)c2cccc3cccc1c23]

a naphthalimide derivative, a disazomethine derivative: RCH═N—N═CHR, or mixture of these compounds. Some specific examples include Solvent Green 7 (pyranine), Acid Yellow 184 (a coumarin derivative), Acid Yellow 250 (a coumarin derivative), Yellow 101 (Aldazine:

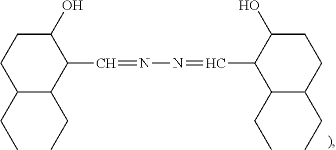 [SMILES: CCC1CCC(O)C(C=NN=CC2C(O)CCC(CC)C2CC)C1CC]

Basic Yellow 40 (a coumarin derivative), Solvent Yellow 43 (a naphthalimide derivative), Solvent Yellow 44 (a naphthalimide derivative), Solvent Yellow 85 (a naphthalimide derivative), Solvent Yellow 145 (a coumarin derivative), Solvent Yellow 160:1 (a coumarin derivative), and combinations thereof.

The fluorescent yellow dye may be present in the UV light fusing agent in an amount ranging from about 1 wt % active to about 10 wt % active, based on a total weight of the UV light fusing agent. In another example, the fluorescent yellow dye may be present in the fusing agent in an amount ranging from about 5 wt % active to about 8 wt % active, or from about 5.5 wt % active to about 7.5 wt % active.

### Fusing Agent Vehicle

Any example of the fusing agent (core fusing agent, primer fusing agent, UV light fusing agent) includes a liquid vehicle. The fusing agent vehicle, or “FA vehicle,” may refer to the liquid in which the energy absorber is/are dispersed or dissolved to form the respective fusing agent. A wide variety of FA vehicles, including aqueous and non-aqueous vehicles, may be used in the fusing agents. In some examples, the FA vehicle may include water alone or a non-aqueous solvent alone, i.e., with no other components. In other examples, the FA vehicle may include other components, depending, in part, upon the applicator that is to be used to dispense the fusing agent. Examples of other suitable fusing agent components include co-solvent(s), humectant(s), surfactant(s), anti-microbial agent(s), anti-kogation agent(s), chelating agent(s), buffer(s), pH adjuster(s), preservative(s), and/or combinations thereof.

Classes of water soluble or water miscible organic co-solvents that may be used in the fusing agents include aliphatic alcohols, aromatic alcohols, diols, glycol ethers, polyglycol ethers, lactams, formamides (substituted and unsubstituted), acetamides (substituted and unsubstituted), glycols, and long chain alcohols. Examples of these co-solvents include primary aliphatic alcohols, secondary aliphatic alcohols, 1,2-alcohols (e.g., 1,2-ethanediol, 1,2-propanediol, etc.), 1,3-alcohols (e.g., 1,3-propanediol), 1,5-alcohols (e.g., 1,5-pentanediol), 1,6-hexanediol or other diols (e.g., 2-methyl-1,3-propanediol, etc.), ethylene glycol alkyl ethers, propylene glycol, propylene glycol alkyl ethers, higher homologs (C₆-C₁₂) of polyethylene glycol alkyl ethers, diethylene glycol, triethylene glycol, tripropylene glycol methyl ether, tetraethylene glycol, glycerol, N-alkyl caprolactams, unsubstituted caprolactams, 2-pyrrolidone, 1-methyl-2-pyrrolidone, 1-(2-hydroxyethyl)-2-pyrrolidone, and the like. Other examples of organic co-solvents include dimethyl sulfoxide (DMSO), isopropyl alcohol, ethanol, pentanol, acetone, or the like.

The co-solvent(s) may be present in the fusing agent in a total amount ranging from about 1 wt % active to about 20 wt % active based upon the total weight of the fusing agent. In an example, the fusing agent includes from about 2 wt % active to about 15 wt % active, or from about 5 wt % active to about 10 wt % active of the co-solvent(s).

The FA vehicle may also include humectant(s). An example of a suitable humectant is ethoxylated glycerin having the following formula:

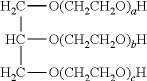

in which the total of a+b+c ranges from about 5 to about 60, or in other examples, from about 20 to about 30. An example of the ethoxylated glycerin is LIPONIC® EG-1 (LEG-1, glycereth-26, a+b+c=26, available from Lipo Chemicals).

In an example, the total amount of the humectant(s) present in the fusing agent ranges from about 3 wt % active to about 10 wt % active, based on the total weight of the fusing agent.

The FA vehicle may also include surfactant(s). Suitable surfactant(s) include non-ionic or anionic surfactants. Some example surfactants include alcohol ethoxylates, alcohol ethoxysulfates, acetylenic diols, alkyl polyethylene oxides, alkyl phenyl polyethylene oxides, polyethylene oxide block copolymers, acetylenic polyethylene oxides, polyethylene oxide (di) esters, polyethylene oxide amines, protonated polyethylene oxide amines, protonated polyethylene oxide amides, dimethicone copolyols, substituted amine oxides, fluorosurfactants, and the like. Some specific examples of non-ionic surfactants include the following from Evonik Degussa: SURFYNOL® SEF (a self-emulsifiable, wetting agent based on acetylenic diol chemistry), SURFYNOL® 440 or SURFYNOL® CT-111 (non-ionic ethoxylated low-foam wetting agents), SURFYNOL® 420 (non-ionic ethoxylated wetting agent and molecular defoamer), SURFYNOL® 104E (non-ionic wetting agents and molecular defoamer), and TEGO® Wet 510 (organic surfactant). Other specific examples of non-ionic surfactants include the following from The Dow Chemical Company: TERGITOL™ TMN-6, TERGITOL™ 15-S-7, TERGITOL™ 15-S-9, TERGITOL™ 15-S-12 (secondary alcohol ethoxylates). Other suitable non-ionic surfactants are available from Chemours, including the CAPSTONE® fluorosurfactants, such as CAPSTONE® FS-35 (a non-ionic fluorosurfactant). Some specific examples of anionic surfactants include alkyldiphenyloxide disulfonate (e.g., the DOWFAX™ series, such a 2A1, 3B2, 8390, C6L, C10L, and 30599, from The Dow Chemical Company), docusate sodium (i.e., dioctyl sodium sulfosuccinate), sodium dodecyl sulfate (SDS).

Whether a single surfactant is used or a combination of surfactants is used, the total amount of surfactant(s) in the fusing agent may range from about 0.01 wt % active to about 3 wt % active based on the total weight of the fusing agent. In an example, the total amount of surfactant(s) in the fusing agent may be about 1 wt % active based on the total weight of the build material reactive functional agent.

The FA vehicle may also include anti-microbial agent(s). Anti-microbial agents are also known as biocides and/or fungicides. Examples of suitable anti-microbial agents include the NUOSEPT® (Ashland Inc.), UCARCIDE™ or KORDEK™ or ROCIMA™ (The Dow Chemical Company), PROXEL® (Arch Chemicals) series, ACTICIDER B20 and ACTICIDER M20 and ACTICIDER MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (The Dow Chemical Company), and combinations thereof.

In an example, the total amount of anti-microbial agent(s) in the fusing agent ranges from about 0.01 wt % active to about 0.05 wt % active (based on the total weight of the fusing agent). In another example, the total amount of anti-microbial agent(s) in the fusing agent is about 0.04 wt % active (based on the total weight of the fusing agent).

The FA vehicle may also include anti-kogation agent(s) that is/are to be jetted using thermal inkjet printing. Kogation refers to the deposit of dried printing liquid (e.g., fusing agent) on a heating element of a thermal inkjet printhead. Anti-kogation agent(s) is/are included to assist in preventing the buildup of kogation.

Examples of suitable anti-kogation agents include oleth-3-phosphate (commercially available as CRODAFOS™ 03A or CRODAFOS™ N-3A) or dextran 500k. Other suitable examples of the anti-kogation agents include CRODAFOST HCE (phosphate-ester from Croda Int.), CRODAFOS® 010A (oleth-10-phosphate from Croda Int.), or DISPERSOGEN® LFH (polymeric dispersing agent with aromatic anchoring groups, acid form, anionic, from Clariant), etc. It is to be understood that any combination of the anti-kogation agents listed may be used.

The anti-kogation agent may be present in the fusing agent in an amount ranging from about 0.1 wt % active to about 1.5 wt % active, based on the total weight of the fusing agent. In an example, the anti-kogation agent is present in an amount of about 0.5 wt % active, based on the total weight of the fusing agent.

Chelating agents (or sequestering agents) may be included in the liquid vehicle of the fusing agent to eliminate the deleterious effects of heavy metal impurities. In an example, the chelating agent is selected from the group consisting of methylglycinediacetic acid, trisodium salt; 4,5-dihydroxy-1,3-benzenedisulfonic acid disodium salt monohydrate; ethylenediaminetetraacetic acid (EDTA); hexamethylenediamine tetra(methylene phosphonic acid), potassium salt; and combinations thereof. Methylglycinediacetic acid, trisodium salt (Na3MGDA) is commercially available as TRILON® M from BASF Corp. 4,5-dihydroxy-1,3-benzenedisulfonic acid disodium salt monohydrate is commercially available as TIRON™ monohydrate. Hexamethylenediamine tetra(methylene phosphonic acid), potassium salt is commercially available as DEQUEST® 2054 from Italmatch Chemicals.

Whether a single chelating agent is used or a combination of chelating agents is used, the total amount of chelating agent(s) in the fusing agent may range from greater than 0 wt % active to about 0.5 wt % active based on the total weight of the fusing agent. In an example, the chelating agent is present in an amount ranging from about 0.05 wt % active to about 0.2 wt % active based on the total weight of fusing agent. In another example, the chelating agent(s) is/are present in the fusing agent in an amount of about 0.05 wt % active (based on the total weight of the fusing agent).

Some examples of the fusing agent include a buffer. The buffer may be TRIS (tris(hydroxymethyl)aminomethane or TRIZMA®), TRIS or TRIZMAR hydrochloride, bis-tris propane, TES (2-[(2-Hydroxy-1,1-bis(hydroxymethyl)ethyl)aminolethanesulfonic acid), MES (2-ethanesulfonic acid), MOPS (3-(N-morpholino) propanesulfonic acid), HEPES (4-(2-hydroxyethyl)-1-piperazineethanesulfonic acid), DIPSO (3-(N,N-Bis [2-hydroxyethyl]amino)-2-hydroxypropanesulfonic acid), Tricine (N-[tris(hydroxymethyl)methyl]glycine), HEPPSO (β-Hydroxy-4-(2-hydroxyethyl)-1-piperazinepropanesulfonic acid monohydrate), POPSO (Piperazine-1,4-bis(2-hydroxypropanesulfonic acid)dihydrate), EPPS (4-(2-Hydroxyethyl)-1-piperazinepropanesulfonic acid, 4-(2-Hydroxyethyl) piperazine-1-propanesulfonic acid), TEA (triethanolamine buffer solution), Gly-Gly (Diglycine), bicine (N,N-Bis(2-hydroxyethyl)glycine), HEPBS (N-(2-Hydroxyethyl) piperazine-N′-(4-butanesulfonic acid)), TAPS ([tris(hydroxymethyl)methylamino]propanesulfonic acid), AMPD (2-amino-2-methyl-1,3-propanediol), TABS (N-tris(Hydroxymethyl)methyl-4-aminobutanesulfonic acid), or the like.

In an example, the total amount of buffer(s) in the fusing agent ranges from about 0.01 wt % to about 3 wt % (based on the total weight of the fusing agent).

Some examples of the fusing agent include a pH adjuster. Suitable pH adjusters may include amino acids or sodium bicarbonate. An example of a suitable amino acid pH adjuster is taurine. In an example, the total amount of the pH adjuster(s) in the fusing agent ranges from about 0.01 wt % to about 3 wt % (based on the total weight of the fusing agent).

Some examples of the fusing agent include a preservative. Preservatives may be particular suitable when vitamin B or a vitamin B derivative is used as the energy absorber. Examples of suitable preservatives include 2-phenoxyethanol, sodium benzoate, and parabens. In an example, the total amount of the preservative(s) in the fusing agent ranges from about 0.1 wt % to about 3 wt % (based on the total weight of the fusing agent).

Some examples of the fusing agent, particularly the UV light fusing agent, also include a base. In some examples, the B vitamin or the B vitamin derivative is more soluble at a neutral or basic pH. For example, folic acid is more soluble in an aqueous vehicle having a pH greater than 5. As such, it may be desirable to add a base, such as potassium hydroxide, sodium hydroxide, or tetramethylammonium hydroxide, until the desired pH is obtained. In an example, the total amount of the base in the fusing agent ranges from about 0.5 wt % to about 5 wt % (based on the total weight of the fusing agent). In other examples, the amount of base may range from about 0.75 wt % to about 2.5 wt %.

The balance of any example of the fusing agent is water (e.g., deionized water, purified water, etc.). The amount of water may vary depending upon the amounts of the other components in the fusing agent. In one example, the fusing agent is jettable via a thermal inkjet printhead, and includes from about 50 wt % to about 90 wt % water.

### Detailing Agent

The 3D manufacturing method that involves the selective application of the fusing agent to pattern the layer of the build material composition may also involve the selective application of a detailing agent. The detailing agent does not include an energy absorber, and may be applied to portion(s) of the build material composition that are outside of the 3D object model. The portion(s) of the build material composition exposed to the detailing agent may experience a cooling effect, and thus the detailing agent helps to keep the portion(s) from coalescing.

The detailing agent may include a surfactant, a co-solvent, and a balance of water. In some examples, the detailing agent consists of these components, and no other components. In some other examples, the detailing agent may further include a colorant. In still some other examples, the detailing agent consists of a colorant, a surfactant, a co-solvent, and a balance of water, with no other components. In yet some other examples, the detailing agent may further include additional components, such as anti-kogation agent(s), anti-microbial agent(s), and/or chelating agent(s) (each of which is described above in reference to the fusing agent).

The surfactant(s) that may be used in the detailing agent include any of the surfactants listed herein in reference to the fusing agent. The total amount of surfactant(s) in the detailing agent may range from about 0.10 wt % active to about 5.00 wt % active with respect to the total weight of the detailing agent.

The co-solvent(s) that may be used in the detailing agent include any of the co-solvents listed above in reference to the fusing agent. The total amount of co-solvent(s) in the detailing agent may range from about 1 wt % active to about 65 wt % active with respect to the total weight of the detailing agent.

In some examples, the detailing agent does not include a colorant. In these examples, the detailing agent may be colorless. As used herein, “colorless,” means that the detailing agent is achromatic and does not include a colorant. The colorless detailing agent may be used with any of the fusing agents disclosed herein.

In other examples, the detailing agent does include a colorant. It may be desirable to add color to the detailing agent when the detailing agent is applied to the edge of a colored 3D object, such as an object formed using the core fusing agent. Color in the detailing agent may be desirable when used at a part edge because some of the colorant may become embedded in the build material composition that fuses/coalesces at the edge. As such, in some examples, the dye in the detailing agent may be selected so that its color matches the color of the energy absorber in the fusing agent. As examples, the dye may be any azo dye having sodium or potassium counter ion(s) or any diazo (i.e., double azo) dye having sodium or potassium counter ion(s), where the color of azo or dye azo dye matches the color of the fusing agent.

When the detailing agent includes the colorant and is to be used with the core fusing agent, the colorant may be a dye of any color having substantially no absorbance in a range of 650 nm to 2500 nm. By “substantially no absorbance” it is meant that the dye absorbs no radiation having wavelengths in a range of 650 nm to 2500 nm, or that the dye absorbs less than 10% of radiation having wavelengths in a range of 650 nm to 2500 nm. The dye may also be capable of absorbing radiation with wavelengths of 650 nm or less. As such, the dye absorbs at least some wavelengths within the visible spectrum, but absorbs little or no wavelengths within the near-infrared spectrum. This is in contrast to the energy absorber in the core fusing agent, which absorbs wavelengths within the near-infrared spectrum. As such, the colorant in the detailing agent will not substantially absorb the fusing radiation, and thus will not initiate melting and fusing (coalescence) of the build material composition in contact therewith when the build material layer is exposed to the energy.

In an example, the dye is a black dye. Some examples of the black dye include azo dyes having sodium or potassium counter ion(s) and diazo (i.e., double azo) dyes having sodium or potassium counter ion(s). Examples of azo and diazo dyes may include tetrasodium (6Z)-4-acetamido-5-oxo-6-[7-sulfonato-4-(4-sulfonatophenyl) azo-1-naphthyllhydrazono]naphthalene-1,7-disulfonate with a chemical structure of:

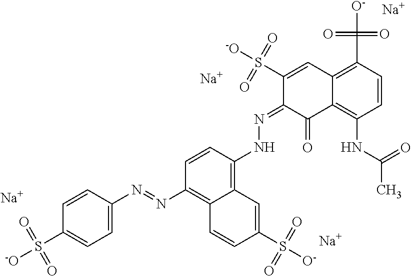

(commercially available as Food Black 1); tetrasodium 6-amino-4-hydroxy-3-[[7-sulfonato-4-[(4-sulfonatophenyl) azo]-1-naphthyl]azo]naphthalene-2,7-disulfonate with a chemical structure of:

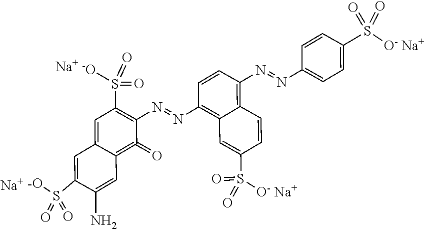

(commercially available as Food Black 2); tetrasodium (6E)-4-amino-5-oxo-3-[4-(2-sulfonatooxyethylsulfonyl)phenyl]diazenyl]-6-[4-(2-sulfonatooxyethylsulfonyl)phenyl]hydrazinylidene]naphthalene-2,7-disulfonate with a chemical structure of:

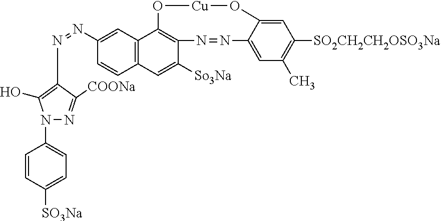

(commercially available as Reactive Black 31); tetrasodium (6E)-4-amino-5-oxo-3-[4-(2-sulfonatooxyethylsulfonyl)phenyl]diazenyl]-6-[4-(2-sulfonatooxyethylsulfonyl)phenyl]hydrazinylidene]naphthalene-2,7-disulfonate with a chemical structure of:

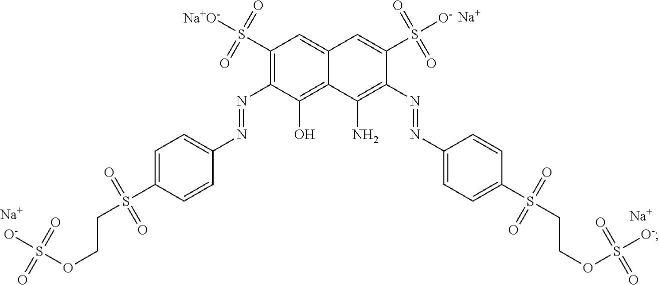

and combinations thereof. Some other commercially available examples of the dye used in the detailing agent include multipurpose black azo-dye based liquids, such as PRO-JET® Fast Black 1 (made available by Fujifilm Holdings), and black azo-dye based liquids with enhanced water fastness, such as PRO-JET® Fast Black 2 (made available by Fujifilm Holdings).

In some instances, in addition to the black dye, the colorant in the detailing agent may further include another dye. In an example, the other dye may be a cyan dye that is used in combination with any of the dyes disclosed herein. The other dye may also have substantially no absorbance above 650 nm. The other dye may be any colored dye that contributes to improving the hue and color uniformity of the final 3D printed polyamide object.

Some examples of the other dye include a salt, such as a sodium salt, an ammonium salt, or a potassium salt. Some specific examples include ethyl-[4-[4-[ethyl-[(3-sulfophenyl)methyl]amino]phenyl]-(2-sulfophenyl)ethylidene]-1-cyclohexa-2,5-dienylidene]-[(3-sulfophenyl)methyl]azanium with a chemical structure of:

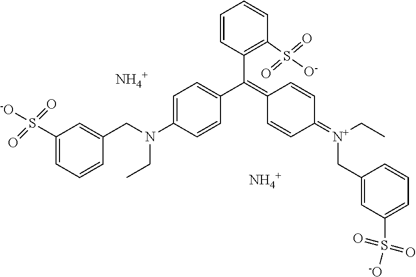

(commercially available as Acid Blue 9, where the counter ion may alternatively be sodium counter ions or potassium counter ions); sodium 4-[(E)-{4-[benzyl(ethyl)amino]phenyl}{(4E)-4-[benzyl(ethyl)iminio]cyclohexa-2,5-dien-1-ylidene}methyl]benzene-1,3-disulfonate with a chemical structure of:

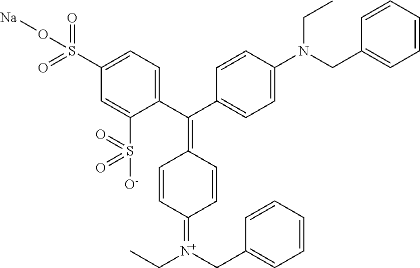

(commercially available as Acid Blue 7); and a phthalocyanine with a chemical structure of:

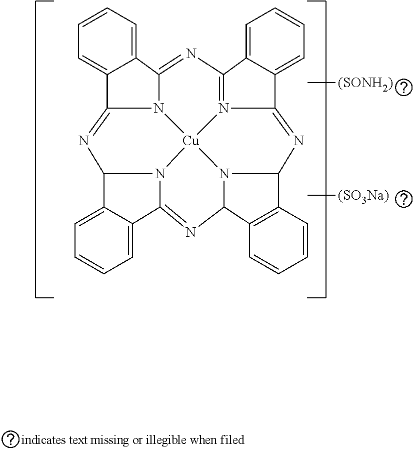

(commercially available as Direct Blue 199); and combinations thereof.

In an example of the detailing agent, the dye may be present in an amount ranging from about 1 wt % active to about 3 wt % active based on the total weight of the detailing agent. In another example of the detailing agent including a combination of dyes, one dye (e.g., the black dye) is present in an amount ranging from about 1.50 wt % active to about 1.75 wt % active based on the total weight of the detailing agent, and the other dye (e.g., the cyan dye) is present in an amount ranging from about 0.25 wt % active to about 0.50 wt % active based on the total weight of the detailing agent.

The balance of the detailing agent is water. As such, the amount of water may vary depending upon the amounts of the other components that are included.

### Coloring Agent

The 3D manufacturing method that involves the selective application of the fusing agent to pattern the layer of the build material composition may also involve the selective application of a coloring agent. The coloring agent may be used to impart color to the 3D object.

In these examples, the coloring agent is separate from the fusing agent. A coloring agent separate from the fusing agent may be desirable because the two agents can be applied separately, thus allowing control over where color is added. The coloring agent may be applied during printing (e.g., on the build material composition with the fusing agent) or after printing (e.g., on a 3D printed object) to impart a colored appearance to the 3D printed object.

The coloring agent may include a colorant, a co-solvent, and a balance of water. In some examples, the coloring agent of these components, and no other components. In still other examples, the coloring agent may further include additional components that aid in colorant dispersability and/or ink jettability. Some examples of additional coloring agent components include dispersant(s) (e.g., a water-soluble acrylic acid polymer (e.g., CARBOSPERSER K7028 available from Lubrizol), water-soluble styrene-acrylic acid copolymers/resins (e.g., JONCRYL® 296, JONCRYL® 671, JONCRYL® 678, JONCRYL® 680, JONCRYL® 683, JONCRYL® 690, etc. available from BASF Corp.), a high molecular weight block copolymer with pigment affinic groups (e.g., DISPERBYK®-190 available BYK Additives and Instruments), or water-soluble styrene-maleic anhydride copolymers/resins), humectant(s), surfactant(s), anti-kogation agent(s), and/or antimicrobial agent(s) (examples of which are described herein in reference to the fusing agent).

The coloring agent may be a black agent, a cyan agent, a magenta agent, or a yellow agent. As such, the colorant may be a black colorant, a cyan colorant, a magenta colorant, a yellow colorant, or a combination of colorants that together achieve a black, cyan, magenta, or yellow color. While some examples have been provided, it is to be understood that other colored inks may also be used.

The colorant of the coloring agent may be any pigment or dye. When the coloring agent is a separate agent, the pigment or dye is to impart color, and is not meant to replace the energy absorber in the fusing agent. As such, the colorant may function as an energy absorber or as a partial energy absorber, or may not provide any energy absorption.

An example of the pigment based colored ink may include from about 1 wt % to about 10 wt % of pigment(s), from about 10 wt % to about 30 wt % of co-solvent(s), from about 1 wt % to about 10 wt % of dispersant(s), 0.01 wt % to about 1 wt % of anti-kogation agent(s), from about 0.05 wt % to about 0.1 wt % anti-microbial agent(s), and a balance of water. An example of the dye based colored ink may include from about 1 wt % to about 7 wt % of dye(s), from about 10 wt % to about 30 wt % of co-solvent(s), from about 1 wt % to about 7 wt % of dispersant(s), from about 0.05 wt % to about 0.1 wt % antimicrobial agent(s), from 0.05 wt % to about 0.1 wt % of chelating agent(s), from about 0.005 wt % to about 0.2 wt % of buffer(s), and a balance of water.

### Sets and Kits

The build material composition disclosed herein may be part of a 3D printing kit with any example of the fusing agent (e.g., core, primer, and/or UV light) disclosed herein. In one example, the kit is a single fusing agent kit that includes the build material composition and one of the fusing agents (e.g., the core fusing agent, the primer fusing agent, or the UV light fusing agent). In one example, the kit is a multi-fusing agent kit that includes the build material composition and two or more of the fusing agents (e.g., the core fusing agent and the primer fusing agent).

Any example of the 3D printing kit may also be a multi-fluid kit, which includes one or more of the fusing agents, as well as the detailing agent and/or the coloring agent.

It is to be understood that the fluid(s) and the build material composition of the 3D printing kits may be maintained separately until used together in examples of the 3D printing method disclosed herein. The fluid(s) and/or compositions may each be contained in one or more containers prior to and during printing, but may be combined together during printing. The containers can be any type of a vessel (e.g., a reservoir), box, or receptacle made of any material.

### Printing Methods

The build material composition disclosed herein may be used in 3D printing techniques that utilize one or more of the fusing agents disclosed herein. The 3D printing method generally includes spreading the build material composition to form a build material layer, the build material composition including: polyamide-12 particles present in an amount of at least 55 wt % based on a total weight of the build material composition; solid glass beads present in an amount ranging from about 5 wt % to less than 15 wt % based on the total weight of the build material composition; and glass fibers having an average aspect ratio ranging from about 12:1 to about 20:1 and an average length ranging from about 200 μm to less than 300 μm, the glass fibers being present in an amount ranging from about 15 wt % to about 25 wt % based on the total weight of the build material composition; based on a 3D object model, selectively applying a fusing agent on at least a portion of the build material layer; and exposing the build material layer to electromagnetic radiation to coalesce the build material composition in the at least the portion, thereby forming a layer of a 3D object. To form the 3D object, the method may be repeated. As such, the method may further include iteratively applying individual build material layers of the build material composition; based on the 3D object model, selectively applying the fusing agent to at least some of the individual build material layers to define individually patterned layers; and iteratively exposing the individually patterned layers to the electromagnetic radiation to form individual object layers.

An example of the 3D object (i.e., 3D printed article) disclosed herein includes coalesced build material, which includes the polyamide-12 particles, the glass beads, and the glass fibers (with or without one or more of the additives disclosed herein). When the 3D printing technique utilized to generate the 3D printed article involves the selective application of the fusing agent, the 3D printed article also includes an energy absorber intermingled with the coalesced build material. The 3D printed article may also include the coloring agent applied on an exterior of the 3D printed article or incorporated into at least a portion of the coalesced build material, the coloring agent being selected from the group consisting of a black agent, a cyan agent, a magenta agent, and a yellow agent.

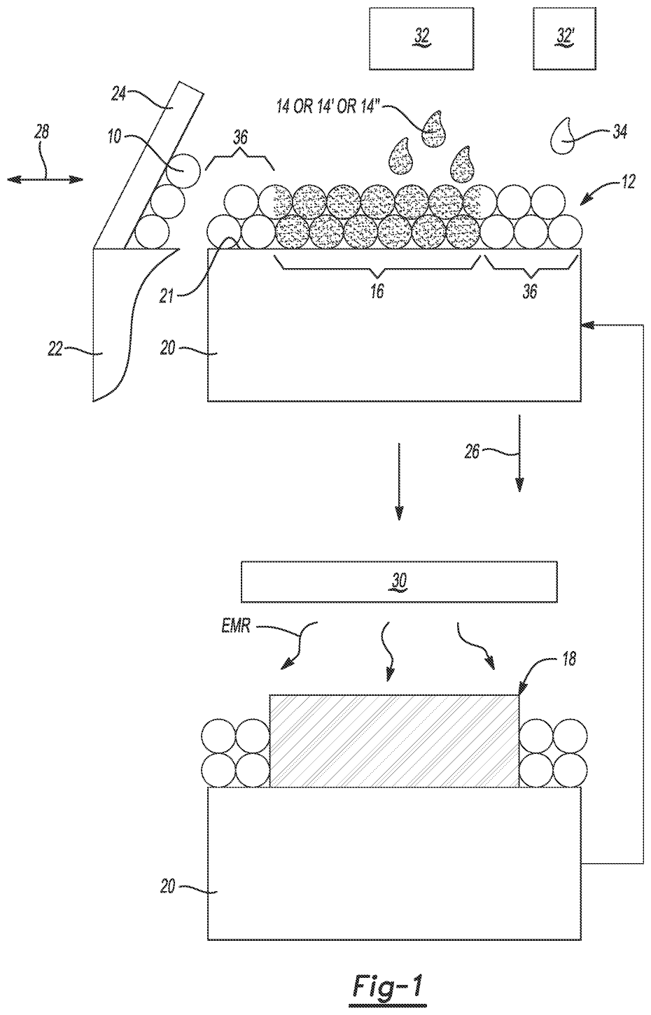

Different examples of the 3D printing method that utilize the fusing agent(s) are shown and described in reference to FIG. 1 through FIG. 4.

Prior to execution of any examples of the method, it is to be understood that a controller may access data stored in a data store pertaining to a 3D part/object that is to be printed. The data may include a digital model of the 3D part/object that is to be build, and additional data, for example, the number of layers of the build material composition that are to be formed, the locations at which any of the agents is/are to be deposited on each of the respective layers, etc. may be derived from this digital 3D object model.

Printing with One Fusing Agent

Referring now to FIG. 1, an example of a 3D printing method which utilizes one of the fusing agents is schematically depicted.

The method shown in FIG. 1 includes spreading the build material composition 10 to form a build material layer 12; based on a 3D object model, selectively applying a fusing agent (e.g., core fusing agent 14, primer fusing agent 14′, UV light fusing agent 14″) onto the build material layer 12, thereby forming a patterned portion 16; and exposing the build material layer 12 to electromagnetic radiation EMR to selectively coalesce the patterned portion 16 and form a 3D printed object layer 18.

Prior to spreading, the method may further include applying the build material composition 10 to a build area platform 20 having an X-Y plane (at surface 21). In FIG. 1, the layer 12 of the build material composition 10 is formed on the build area platform 20. A printing system may be used to apply the build material composition 10. The printing system may include the build area platform 20, a build material supply 22 containing the build material composition 10, and a build material distributor 24.

The surface 21 of the build area platform 20 provides the X-Y plane for building the 3D printed object. The surface 21 receives the build material composition 10 from the build material supply 22. The build area platform 20 may be moved in the directions as denoted by the arrow 26, e.g., along the Z-axis, so that the build material composition 10 may be delivered to the build area platform 20 or to a previously formed layer. In an example, when the build material composition 10 is to be delivered, the build area platform 20 may be programmed to advance (e.g., downward) enough so that the build material distributor 24 can push the build material composition 10 onto the build area platform 20 to form a substantially uniform layer 12 of the build material composition 10 thereon. The build area platform 20 may also be returned to its original position, for example, when a new part is to be built.

The build material supply 22 may be a container, bed, or other surface that is to position the build material composition 10 between the build material distributor 24 and the build area platform 20. The build material supply 22 may include heaters so that the build material composition 10 is heated to a supply temperature ranging from about 25° C. to about 150° C. In these examples, the supply temperature may depend, in part, on the build material composition 10 used and/or the 3D printer used. As such, the range provided is one example, and higher or lower temperatures may be used.

The build material distributor 24 may be moved in the directions as denoted by the arrow 28, e.g., along the Y-axis, over the build material supply 22 and across the build area platform 20 to spread the layer 12 of the build material composition 10 over the build area platform 20. In this example, the spreading is performed in the Y-direction of the X-Y plane. The build material distributor 24 may also be returned to a position adjacent to the build material supply 22 following the spreading of the build material composition 10. The build material distributor 24 may be a blade (e.g., a doctor blade), a roller, a combination of a roller and a blade, and/or any other device capable of spreading the build material composition 10 over the build area platform 20. For instance, the build material distributor 24 may be a counter-rotating roller. In some examples, the build material supply 22 or a portion of the build material supply 22 may translate along with the build material distributor 24 such that build material composition 10 is delivered continuously to the build area platform 20 rather than being supplied from a single location at the side of the printing system as depicted in FIG. 1.

The build material supply 22 may supply the build material composition 10 into a position so that it is ready to be spread onto the build area platform 20. The build material distributor 24 may spread the supplied build material composition 10 onto the build area platform 20. The controller (not shown) may process “control build material supply” data, and in response, control the build material supply 22 to appropriately position the particles of the build material composition 10, and may process “control spreader” data, and in response, control the build material distributor 24 to spread the build material composition 10 over the build area platform 20 to form the layer 12. In FIG. 1, one build material layer 12 has been formed.

The layer 12 has a substantially uniform thickness across the build area platform 20. In an example, the build material layer 12 has a thickness ranging from about 50 μm to about 120 μm. In another example, the thickness of the build material layer 12 ranges from about 30 μm to about 300 μm. It is to be understood that thinner or thicker layers may also be used. For example, the thickness of the build material layer 12 may range from about 20 μm to about 500 μm. The layer thickness may be about 2× (i.e., 2 times) the average particle size (e.g., diameter) of the polyamide-12 particles at a minimum for finer part definition. In some examples, the layer thickness may be about 1.2× the average particle size (e.g., diameter) of the polyamide-12 particles in the build material composition 10.

After the build material composition 10 has been applied and spread, and prior to further processing, the build material layer 12 may be exposed to heating. In an example, the heating temperature may be below the melting point of the polyamide-12 particles in the build material composition 10. As examples, the pre-heating temperature may range from about 10° C. to about 150° C. below the melting point of the polyamide-12 particles. In an example, the pre-heating temperature ranges from about 50° C. to about 170° C.

Pre-heating the layer 12 may be accomplished by using any suitable heat source that exposes all of the build material composition 10 in the layer 12 to the heat. Examples of the heat source include a thermal heat source (e.g., a heater (not shown) integrated into the build area platform 20 (which may include sidewalls)) or a radiation source 30.

After the layer 12 is formed, and in some instances is pre-heated, the fusing agent 14 or 14′ or 14″ is selectively applied on at least some of the build material composition 10 in the layer 12 to form a patterned portion 16.

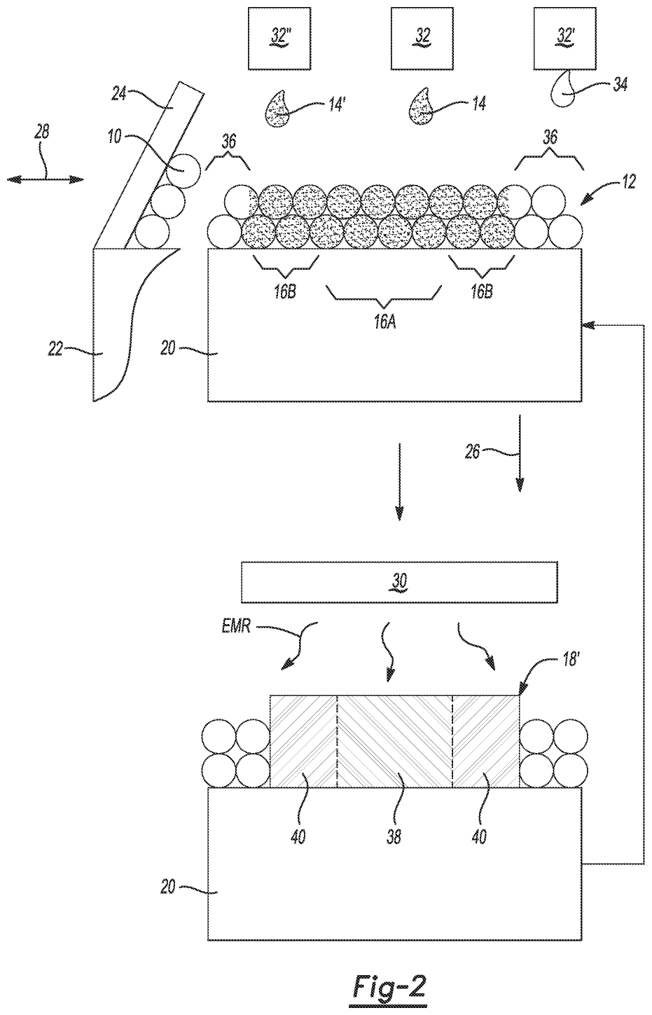

To form a layer 18 of a 3D printed object, at least a portion (e.g., patterned portion 16) of the layer 12 of the build material composition 10 is patterned with the fusing agent 14 or 14′ or 14″. Any of the core fusing agent 14, or the primer fusing agent 14′, or the UV light fusing agent 14″ may be used. When it is desirable to form a white, colored, or slightly tinted object layer 18, the primer fusing agent 14′ or the UV light fusing agent 14″ may be used to pattern the build material composition 10. The primer fusing agent 14′ or the UV light fusing agent 14″ is clear or slightly tinted (depending upon the energy absorber used), and thus the resulting 3D printed object layer 18 may appear white, lightly colored (e.g., yellow), or the color of the build material composition 10. When it is desirable to form a darker color or black object layer 18, the core fusing agent 14 may be used. The core fusing agent 14 is dark or black, and thus the resulting 3D printed object layer 18 may appear grey, black or another dark color. In other examples of the method (e.g., method shown in FIG. 2) the core and primer fusing agents 14 and 14′ may be used to together to pattern different portions of a single build material layer 12, which will be described further in reference to FIG. 2. Color may also be added by using the coloring agent (not shown), which will also be described further in reference to FIG. 4.

The volume of the fusing agent 14 or 14′ or 14″ that is applied per unit of the build material composition 10 in the patterned portion 16 may be sufficient to absorb and convert enough electromagnetic radiation so that the build material composition 10 in the patterned portion 16 will coalesce/fuse. The volume of the fusing agent 14 or 14′ or 14″ that is applied per unit of the build material composition 10 may depend, at least in part, on the energy absorber used, the energy absorber loading in the fusing agent 14 or 14′ or 14″, and the polyamide-12 particles in the build material composition 10.

The fusing agent 14 or 14′ or 14″ may be dispensed from an applicator 32. The applicator 32 may include a thermal inkjet printhead, a piezoelectric printhead, a continuous inkjet printhead, etc., and the selective application of the fusing agent 14 or 14′ or 14″ may be accomplished by thermal inkjet printing, piezo electric inkjet printing, continuous inkjet printing, etc. The controller may process data, and in response, control the applicator 32 to deposit the fusing agent 14 or 14′ or 14″ onto the predetermined portion(s) 16 of the build material composition 10.

It is to be understood that the selective application of the fusing agent 14 or 14′ or 14″ may be accomplished in a single printing pass or in multiple printing passes. In some examples, the fusing agent 14 or 14′ or 14″ is selectively applied in a single printing pass. In some other examples, the fusing agent 14 or 14′ or 14″ is selectively applied in multiple printing passes. In one of these examples, the number of printing passes ranges from 2 to 4. It may be desirable to apply the fusing agent 14 or 14′ or 14″ in multiple printing passes to increase the amount, e.g., of the energy absorber that is applied to the build material composition 10, to avoid liquid splashing, to avoid displacement of the build material composition 10, etc.

In the example shown in FIG. 1, the detailing agent 34 is also selectively applied to the portion(s) 36 of the layer 12. The portion(s) 36 are not patterned with the fusing agent 14 or 14′ or 14″ and thus are not to become part of the final 3D printed object layer 18. Thermal energy generated during radiation exposure may propagate into the surrounding portion(s) 36 that do not have the fusing agent 14 or 14′ or 14″ applied thereto. The propagation of thermal energy may be inhibited, and thus the coalescence of the non-patterned build material portion(s) 36 may be prevented, when the detailing agent 34 is applied to these portion(s) 36.

The detailing agent 34 may also be dispensed from an applicator 32′. The applicator 32′ may include any of the inkjet printheads set forth herein. It is to be understood that the applicators 32, 32′ may be separate applicators or may be a single applicator with several individual fluid supplies and printheads for dispensing the respective agents 14 or 14′ or 14″ and 34. The detailing agent 34 may also be selectively applied in a single printing pass or in multiple printing passes.

After the agents 14 or 14′ or 14″ and 34 are selectively applied in the specific portion(s) 16 and 36 of the layer 12, the entire layer 12 of the build material composition 10 is exposed to electromagnetic radiation (shown as EMR in FIG. 1).

The electromagnetic radiation is emitted from the radiation source 30. The length of time the electromagnetic radiation is applied for, or energy exposure time, may be dependent, for example, on one or more of: characteristics of the radiation source 30 (e.g., power, intensity, etc.); characteristics of the build material composition 10; and/or characteristics of the fusing agent 14 or 14′ or 14″.

It is to be understood that the electromagnetic radiation exposure may be accomplished in a single radiation event or in multiple radiation events. In an example, the exposing of the build material composition 10 is accomplished in multiple radiation events. In a specific example, the number of radiation events ranges from 3 to 8. In still another specific example, the exposure of the build material composition 10 to electromagnetic radiation may be accomplished in 3 radiation events. It may be desirable to expose the build material composition 10 to electromagnetic radiation in multiple radiation events to counteract a cooling effect that may be brought on by the amount of the agents 14 or 14′ and 34 that is applied to the build material layer 12. Additionally, it may be desirable to expose the build material composition 10 to electromagnetic radiation in multiple radiation events to sufficiently elevate the temperature of the build material composition 10 in the portion(s) 16, 36, without over heating the build material composition 10 in the non-patterned portion(s) 36.

The fusing agent 14 or 14′ or 14″ enhances the absorption of the radiation, converts the absorbed radiation to thermal energy, and promotes the transfer of the thermal heat to the build material composition 10 in contact therewith. In an example, the fusing agent 14 or 14′ or 14″ sufficiently elevates the temperature of the build material composition 10 in the portion 16 to a temperature above the melting point of the polyamide-12 particles, allowing coalescing/fusing (e.g., thermal merging, melting, binding, etc.) of the build material composition 10 to take place. The application of the electromagnetic radiation forms the 3D printed object layer 18.

In some examples, the electromagnetic radiation has a wavelength ranging from 100 nm to 400 nm, from 400 nm to 4000 nm, or from 800 nm to 1400 nm, or from 800 nm to 1200 nm. The radiation used will depend upon the fusing agent 14 or 14′ or 14″ that is used. Radiation having wavelengths within the appropriate ranges may be absorbed by the fusing agent 14 or 14′ or 14″ and may heat the build material composition 10 in contact therewith, and may not be absorbed by the non-patterned build material composition 10 in portion(s) 36.

The applicator(s) 32, 32′ and the radiation source 30 may be moved in directions perpendicular to the arrow 28, e.g., along the X-axis, over the build material supply 22 and across the build area platform 20 to pattern and radiate the layer 12 of the build material composition 10 over the build area platform 20. Alternatively, the radiation source 30 may be in a fixed position over the build area platform 20. In some examples of the method, the spreading (of the build material composition 10) is performed in a Y-direction of the X-Y plane; and the selectively applying (of the fusing agent(s) 14, 14′, 14″) is performed in the X-direction of the X-Y plane.

After the 3D printed object layer 18 is formed, additional layer(s) may be formed thereon to create an example of the 3D printed polyamide object. To form the next layer, additional build material composition 10 may be applied on the layer 18. The fusing agent 14 or 14′ or 14″ is then selectively applied on at least a portion of the additional build material composition 10, according to data derived from the 3D object model. The detailing agent 34 may be applied in any area of the additional build material composition 10 where coalescence is not desirable. After the agent(s) 14 or 14′ or 14″ and 34 is/are applied, the entire layer of the additional build material composition 10 is exposed to electromagnetic radiation in the manner described herein. The application of additional build material composition 10, the selective application of the agent(s) 14 or 14′ or 14″ and 34, and the electromagnetic radiation exposure may be repeated a predetermined number of cycles to form the final 3D printed polyamide object in accordance with the 3D object model.

Printing with the Core and Primer Fusing Agents

Referring now to FIG. 2, an example of the 3D printing method with both of the fusing agents 14 and 14′ is depicted.

The method shown in FIG. 2 includes applying a build material composition 10 to form a build material layer 12; based on data derived from a digital 3D object model, selectively applying a core fusing agent 14 onto the build material layer 12, thereby forming a first patterned portion 16A; based on the data derived from the 3D object model, selectively applying a primer fusing agent 14′ onto the build material layer 12, thereby forming a second patterned portion 16B adjacent to the first patterned portion 16A; and exposing the build material layer 12 to electromagnetic radiation EMR to selectively coalesce the patterned portions 16A and 16B and form a 3D printed object layer 18′.

In FIG. 2, one layer 12 of the build material composition 10 is applied on the build area platform 20 as described in reference to FIG. 1. After the build material composition 10 has been applied, and prior to further processing, the build material layer 12 may be exposed to pre-heating as described in reference to FIG. 1.

In this example of the 3D printing method, the core fusing agent 14 is selectively applied on at least some of the build material composition 10 in the layer 12 to form a first patterned portion 16A; and the primer fusing agent(s) 14′ is selectively applied on at least some of the build material composition 10 in the layer 12 to form second patterned portion(s) 16B that are adjacent to the first patterned portion(s) 16A. In one example, the first patterned portion 16A (patterned with the core fusing agent 14) may be located at an interior portion of the build material layer 12 to impart mechanical strength, and the second patterned portion 16B (patterned with the primer fusing agent 14′) may be located at an exterior portion of the build material layer 12 to mask the color of the first patterned portion 16A.

The volume of the core fusing agent 14 that is applied per unit of the build material composition 10 in the first patterned portion 16A may be sufficient to absorb and convert enough electromagnetic radiation so that the build material composition 10 in the patterned portion 16A will coalesce/fuse.

The volume of the primer fusing agent 14′ that is applied per unit of the build material composition 10 in the second patterned portion 16B may be sufficient to absorb and convert enough electromagnetic radiation so that the build material composition 10 in the second patterned portion 16B will coalesce/fuse.

In the example shown in FIG. 2, the detailing agent 34 is also selectively applied to the portion(s) 36 of the layer 12. The portion(s) 36 are not patterned with the fusing agent 14 or 14′ and thus are not to become part of the final 3D printed object layer 18′.

After the agents 14, 14′, and 34 are selectively applied in the specific portion(s) 16A, 16B, and 36 of the layer 12, the entire layer 12 of the build material composition 10 is exposed to electromagnetic radiation (shown as EMR in FIG. 2). Radiation exposure may be accomplished as described in reference to FIG. 1.

In this example, the respective fusing agents 14 and 14′ enhance the absorption of the radiation, convert the absorbed radiation to thermal energy, and promote the transfer of the thermal heat to the build material composition 10 in contact therewith. In an example, the fusing agents 14 and 14′ sufficiently elevate the temperature of the build material composition 10 in the respective portions 16A, 16B to a temperature above the melting point of the polyamide-12 particles, allowing coalescing/fusing (e.g., thermal merging, melting, binding, etc.) of the build material composition 10 to take place. The application of the electromagnetic radiation forms the 3D printed object layer 18′, which, in this example, includes a core portion 38 and primer portions 40 at opposed ends of the core portion 38.

FIG. 2 illustrates one example of how the core fusing agent 14 and the primer fusing agent 14′ may be used together to pattern a single build material layer 12 and form one layer 18′ of the 3D printed object.

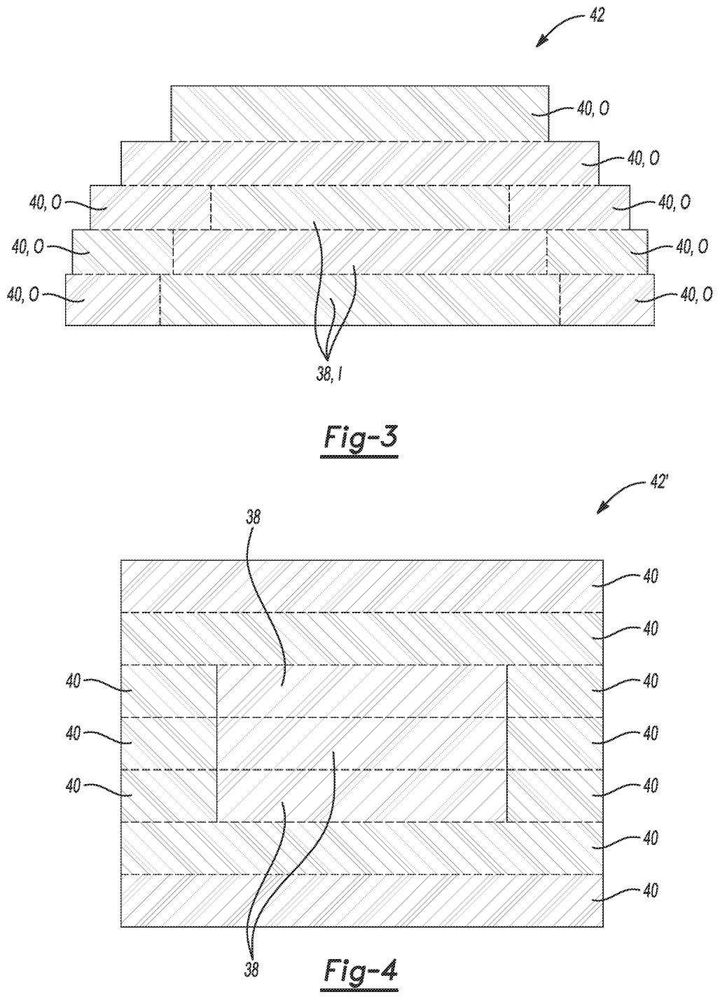

FIG. 3 is a cross-section of a 3D printed object 42 that can be formed with both the core fusing agent 14 and the primer fusing agent 14′. In this example, the 3D printed object 42 includes a predetermined number of core portions 38, and a predetermined number of primer portions 40. To form this example of the 3D printed object 42, the core fusing agent 14 would be applied on multiple layers of the build material composition 10 (illustrated by the dashed horizontal lines in FIG. 3) to pattern and ultimately form the inner core portion 38, I of the 3D printed object 42, and the primer fusing agent 14′ would be applied on multiple layers of the build material composition 10 to pattern and ultimately form the outermost primer portions 40, O of the 3D printed polyamide object 42. After each build material layer 12 is patterned with the agent(s) 14, 14′, electromagnetic radiation may be applied to solidify the respective patterned build material layers.

FIG. 4 is a cross-section of another 3D printed object 42′ that can be formed with both the core fusing agent 14 and the primer fusing agent 14′. In this example, the core fusing agent 14 is utilized to form the core (e.g., the center or inner-most portion) of the 3D printed object 42′, and the primer fusing agent 14′ is used to form the outermost layers of the 3D printed object 42′. The core fusing agent 14 can impart strength to the core of the 3D printed polyamide object 42′, while the primer fusing agent 14′ enables white or a color to be exhibited at the exterior of the 3D printed polyamide object 42′.

To form this example of the 3D printed object 42′, the outermost build material layer(s) and the outermost edges of the middle build material layers would be patterned with the primer fusing agent 14′ to form primer portions 40 of the 3D printed object 42′. The innermost portions of the middle build material layers would be patterned with the core fusing agent 14 to form the core portions 38 of the 3D printed object 42′. In this example, any number of core portions 38 may be formed, and any number of primer portions 40 may be formed.

While several variations of the 3D printed objects 42, 42′ and the combination of the cores and primer fusing agents 14, 14′ have been described, it is to be understood that any of the fusing agents 14, 14′, 14″ may be used to form any desirable 3D printed object.

In any of the example 3D printing methods that utilize the fusing agent(s) 14, 14′, 14″, the coloring agent (not shown) may also be applied with the primer fusing agent 14′ or the UV light fusing agent 14″ to generate color at the exterior surfaces of the 3D printed object, such as object 42 or object 42′. In these examples, the colorant of the coloring agent becomes embedded throughout the coalesced/fused build material composition wherever it is applied. In an example, the coloring agent may be applied with the primer fusing agent 14′ on the portions of the build material layers that form the primer portions 40 in FIG. 4. Since the primer fusing agent 14′ is clear or slightly tinted and the build material composition 10 is white or off-white, the color of the coloring agent will be the color of the resulting primer portions 40. Similarly, since the UV light fusing agent 14″ is clear or slightly tinted and the build material composition 10 is white or off-white, the coloring agent may be used with this fusing agent 14″ to impart color at desirable portions of the resulting 3D printed object.

When core and primer portions 38, 40 are formed (FIG. 3 and FIG. 4) and the coloring agent is used, it is to be understood that some of the primer portions 40 directly adjacent to the core portions 38 may be left uncolored. In this example, the uncolored primer portions 40 are white or slightly tinted, and may function as intermediate layers that help to form a mask over the black (or dark colored) core portions 38. The presence of uncolored primer portions 40 between core portions 38 and primer portions 40 that are colored with the coloring agent may help to optically isolate the core layers 38.

Additionally, in the examples disclosed herein that utilize the fusing agent(s) 14, 14′, 14″, the 3D printed object 42, 42′ may be printed in any orientation with respect to the X-Y plane of the build area platform 20, and thus with respect to the layers 12 of the build material composition 10. For example, the 3D printed object 42, 42′ can be printed from bottom to top in the Z-direction, or at an inverted orientation (e.g., from top to bottom) in the Z-direction. For another example, the 3D printed object 42, 42′ can be printed at an angle or on its side. The orientation of the build within the build material composition 10 can be selected in advance or even by the user at the time of printing, for example.

Because the glass fibers disclosed herein orient themselves in the spreading direction, it may be desirable to print the 3D object in the spreading direction. When an object is printed in a particular direction (e.g., X-, Y-, or Z-direction), it is meant that a load-bearing direction a 3D object being printed extends along the spreading direction. As such, when the build material composition 10 is spread in the Y-direction, it is also desirable that the length of the 3D object being printed also extend along the Y-direction. In this particular example, the 3D object may be printed from bottom to top in the Z-direction, but the load-bearing direction of the 3D object extends in the Y-direction (or the X-direction if that corresponds to the spreading direction).

To further illustrate the present disclosure, examples are given herein. It is to be understood that these examples are provided for illustrative purposes and are not to be construed as limiting the scope of the present disclosure.

### EXAMPLES

### Example 1

Four example build material compositions were prepared by mixing HP HR 3D PA12 powder (HP Inc., included polyamide-12 without additional filler materials, referred to as “PA12 powder”), HP HR 3D PA12 GB powder (HP Inc., included polyamide-12 with glass beads, referred to as “PA12 GB powder”), and silanized glass fibers having an average diameter of 16 μm and an average length of 226 μm (FIBERTECH CO. Ltd.). For the example compositions, the PA12 powder, PA12 GB powder and the glass fibers were mixed in a tumbler mixer (INVERSINA™ 2L, Bioengineering AG) for 4 hours at a rotation speed of 60 rpm. The four example build material compositions included 20 wt % of the glass fibers, but included varying weight fractions of glass beads. Specifically, enough of the HP HR 3D PA12 GB powder was mixed in so that the resulting compositions included 5 wt % (Ex. 1), 10 wt % (Ex. 2), 15 wt % (Ex. 3), and 20 wt % (Ex. 4) of glass beads.

A comparative example build material composition (Comp. Ex. A) was also prepared. The comparative example build material composition included PA12 powder mixed with 20 wt % of the glass fibers. The comparative example build material composition included no glass beads.

The example and comparative example build material compositions were printed using a testbed 3D printer (using a carbon black based fusing agent) to fabricate tensile bars. Multiple tensile bars were printed with each composition according to ASTM D638 Type V standard in the X (radiation source moving direction), Y (roller spreading direction) and Z (bed moving direction) build orientations as defined by ISO/ASTM 52921. Before and after the printing processes, 10 blank layers were deposited to ensure evenly-distributed heating and slow cooling. The cooling process lasted about 40 minutes before collection of the tensile bars. Each tensile bar was exposed to bead blasting, where the glass beads used for blasting had an average diameter of about 83 μm. A high temperature annealing treatment was conducted on the specimens in a tube furnace in place of the annealing process typically conducted in commercial 3D printers. The annealing process was conducted in air and included a heating process at a speed of 5° C./minute, a holding duration of 5 hours at 173° C., and a natural cooling process. To ensure even heating of the specimens, the specimens were placed into a crucible, where the specimens were buried in glass bead powders with an average diameter of 83 μm. The example and comparative tensile bars are named according to the build material composition used (e.g., Ex. 1=tensile bar built with example build material composition Ex. 1).

The weight composition of reinforcements in the example and comparative example tensile bars were evaluated using thermogravimetric analysis (TGA Q500, TA instruments). Specimens from each set of tensile bars were heated to 600° C. at a rate of 10° C./minute and were subsequently cooled to 40° C. at a rate of 10° C./minute. 3 specimens were taken from each set to ensure data reliability.

FIG. 5 shows the residual weight percentage of the example and comparative example tensile bars. The residual weight percentage of all of the tensile bars was found to be within 1.5% of the designed reinforcement weight fraction.

The mechanical properties of the printed tensile bars were characterized by a Shimadzu AGX 10 kN universal tester. At least 4 specimens were tested for each set of tensile bars and the strain speed of the tester was set at 1 mm/minute for all specimens.

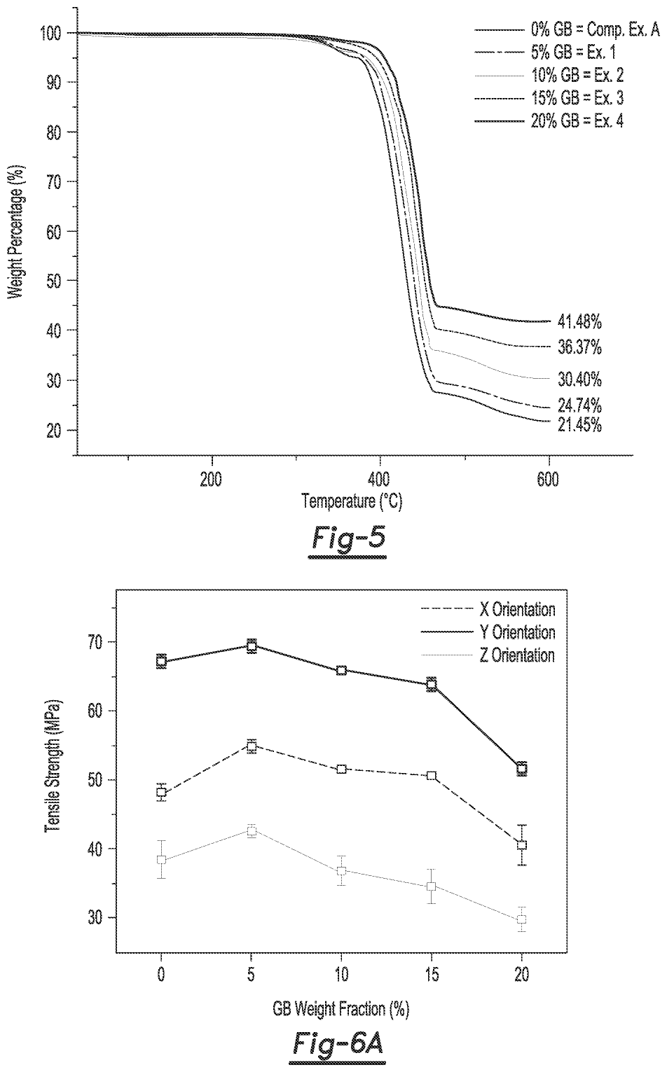

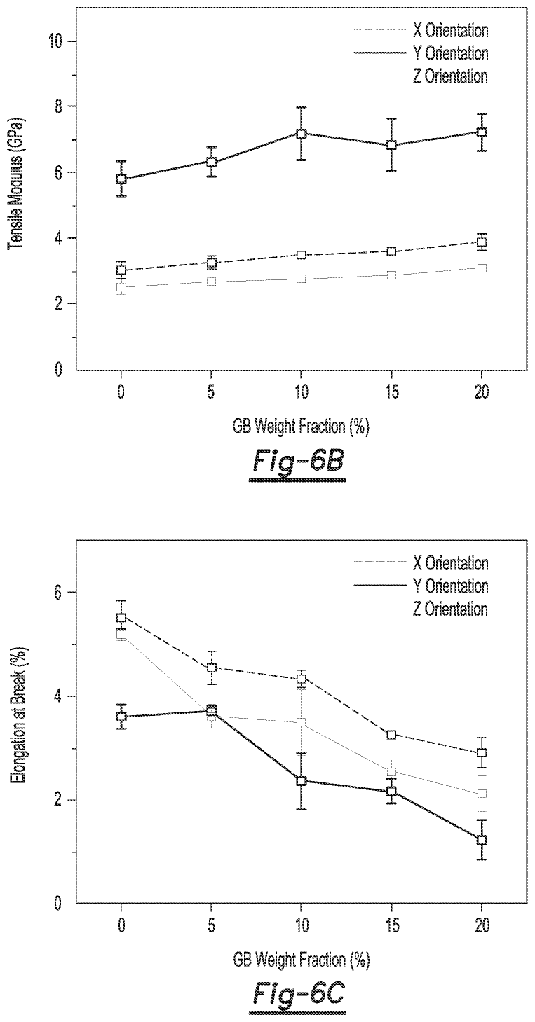

The mechanical properties included ultimate tensile strength (MPa), tensile modulus (GPa), and elongation at break (%), and were tested in each of the X, Y, and Z orientations/directions. The results are shown in Table 1 and in FIG. 6A (ultimate tensile strength), FIG. 6B (tensile modulus), and FIG. 6C (elongation at break).

TABLE 1

| | | Comp. | | | | |
|---|---|---|---|---|---|---|
| | | Ex. A | Ex. 1 | Ex. 2 | Ex. 3 | Ex. 4 |
| | | Tensile | Tensile | Tensile | Tensile | Tensile |
| | | Bars | Bars | Bars | Bars | Bars |
| | | (0 wt % GB) | (5 wt % GB) | (10 wt % GB) | (15 wt % GB) | (20 wt % GB) |
| Ultimate | X- | 48.24 ± | 55.04 ± | 51.59 ± | 50.66 ± | 40.56 ± |
| Tensile | direction | 1.24 | 0.84 | 0.25 | 0.50 | 3.41 |
| Strength | Y- | 67.31 ± | 69.43 ± | 65.96 ± | 64.03 ± | 51.72 ± |
| (MPa) | direction | 0.87 | 0.78 | 0.61 | 2.18 | 0.98 |
| | Z- | 38.54 ± | 42.67 ± | 36.87 ± | 34.62 ± | 29.93 ± |
| | direction | 2.70 | 0.88 | 2.14 | 2.54 | 1.60 |
| Tensile | X- | 3.05 ± | 3.28 ± | 3.50 ± | 3.63 ± | 3.90 ± |
| Modulus | direction | 0.23 | 0.18 | 0.12 | 0.12 | 0.23 |
| (GPa) | Y- | 5.84 ± | 6.35 ± | 7.20 ± | 6.86 ± | 7.25 ± |
| | direction | 0.54 | 0.45 | 0.81 | 0.81 | 0.56 |
| | Z- | 2.53 ± | 2.69 ± | 2.77 ± | 2.90 ± | 3.11 ± |
| | direction | 0.24 | 0.06 | 0.08 | 0.06 | 0.10 |
| Elongation | X- | 5.53 ± | 4.56 ± | 4.35 ± | 3.26 ± | 2.91 ± |
| (%) | direction | 0.33 | 0.32 | 0.17 | 0.04 | 0.30 |
| | Y- | 3.61 ± | 3.71 ± | 2.37 ± | 2.18 ± | 1.24 ± |
| | direction | 0.23 | 0.12 | 0.54 | 0.23 | 0.38 |
| | Z- | 5.18 ± | 3.61 ± | 3.49 ± | 2.54 ± | 2.12 ± |
| | direction | 1.26 | 0.24 | 0.65 | 0.25 | 0.35 |

When the weight fraction of glass beads was 5 wt % (Ex. 1), the UTS and tensile modulus of the tensile bars in the Y orientation was up to 69.44 MPa and 6.35 GPa, respectively. When the weight fraction of glass beads was 10 wt %, the UTS and tensile modulus of the tensile bars in the Y orientation was up to 65.96 MPa and 7.20 GPa, respectively. At the 20 wt % glass fiber loading, the UTS of the tensile bars decreased when the glass bead loading was increased to 15 wt % and 20 wt %. It is believed that a lower glass fiber loading may be used with glass bead loadings between 11 wt % and 14 wt % without seeing a large decrease in UTS.

Overall, the UTS and tensile modulus of the example tensile bars were strongest in the Y direction and weakest in the Z direction. However, Ex. 1 tensile bars printed along the X and Z directions observed a noticeable improvement in both UTS and modulus as compared to the Comp. Ex. A tensile bars. This indicated that small additions of glass beads can provide an isotropic reinforcement to the mechanical properties 3D printed objects.

The stress-strain curves for the Ex. 2 tensile bars in the X direction, Y direction, and Z direction are shown in FIG. 7. The elongation at break was lowest in the Y direction and highest in the X direction.

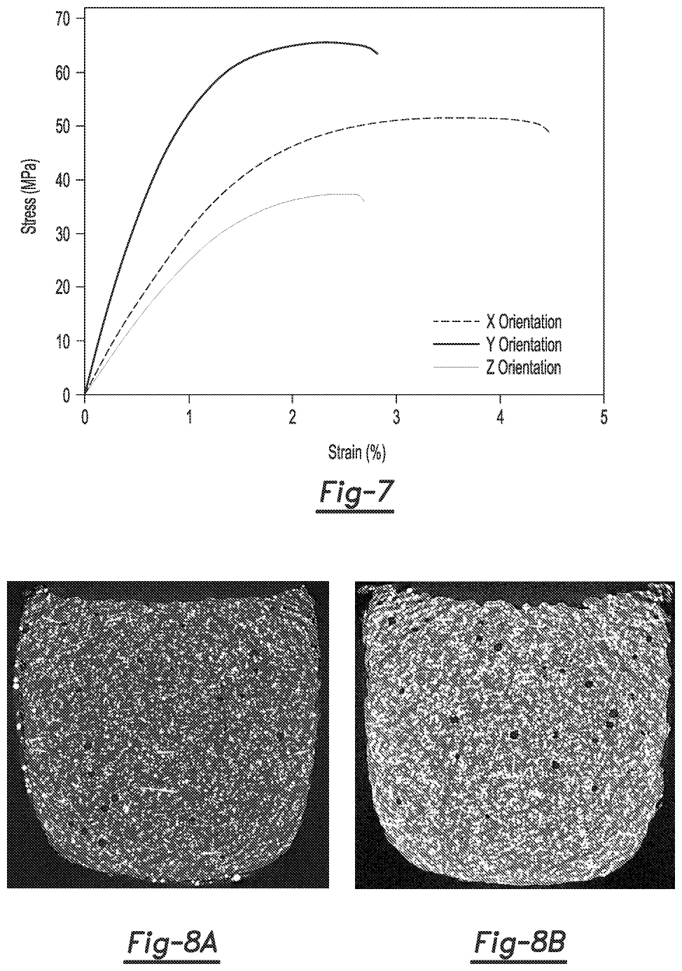

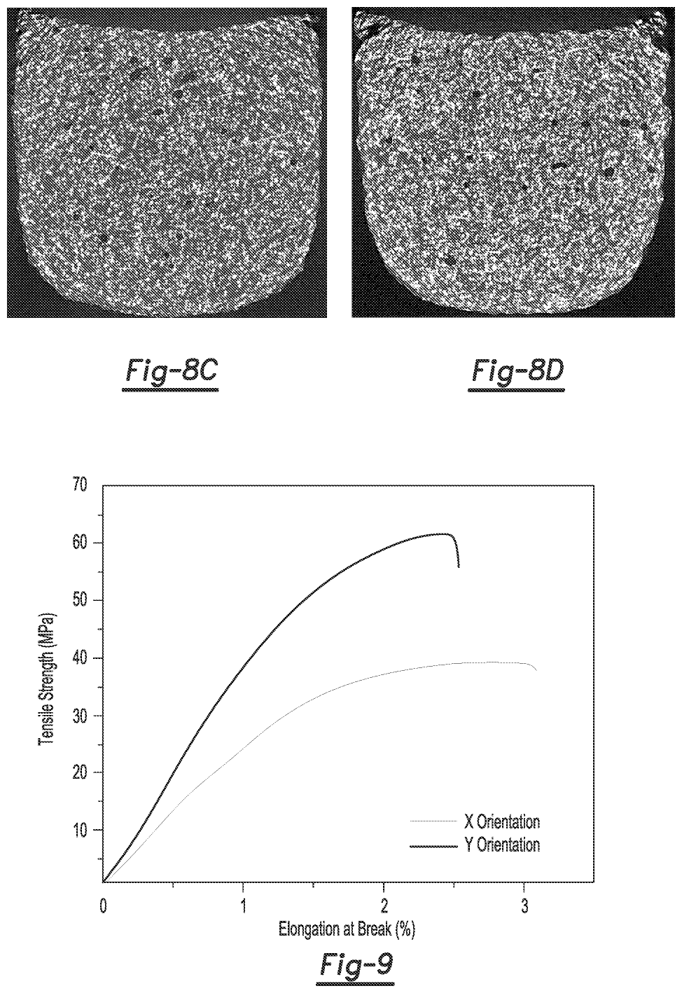

The porosity of the printed tensile bars was evaluated using a Phoenix v|tome|×m MicroCT scanner (GE). For each set of tensile bars, MicroCT analysis was conducted on a 6×3.2×3.2 mm³ volume in the middle portion of one tensile bar using a voxel size of 7.2 μm. The porosities of each example and comparative example tensile bar specimen are shown in Table 2. The MicroCT images of each example tensile bar specimen (Ex. 1 through Ex. 4) are shown in FIG. 8A through FIG. 8D, respectively.

TABLE 2

| | Comp. | | | | |
|---|---|---|---|---|---|
| | Ex. A | Ex. 1 | Ex. 2 | Ex. 3 | Ex. 4 |
| | Tensile | Tensile | Tensile | Tensile | Tensile |
| | Bars | Bars | Bars | Bars | Bars |
| | (0 wt | (5 wt | (10 wt | (15 wt | (20 wt |
| | % GB) | % GB) | % GB) | % GB) | % GB) |
| Porosity | 2.78 | 1.99 | 3.09 | 1.34 | 1.93 |
| (%) | | | | | |

The porosities of all of the example tensile bar specimens (Ex. 1 through Ex. 4) were generally low at <3.1%. These results indicate that the addition of glass bead reinforcement did not adversely affect the 3D object porosity. In fact, the addition of glass beads could fill in the gaps between the glass fibers and the PA12 matrix, leading to the decrease in part porosity.

### Example 2

Build material composition Ex. 1 (5 wt % glass beads, 20 wt % glass fibers, balance PA12) from Example 1 was used in this example. In this example, the Ex. 1 build material composition was printed in the X and Y directions using the commercially available HP Jet Fusion 4200 Industrial 3D Printer (set at PA 12 balanced print mode at 3% fusing irradiance). The annealing process involved exposure to 173° C. for 5 hours, followed by a natural cooling process.

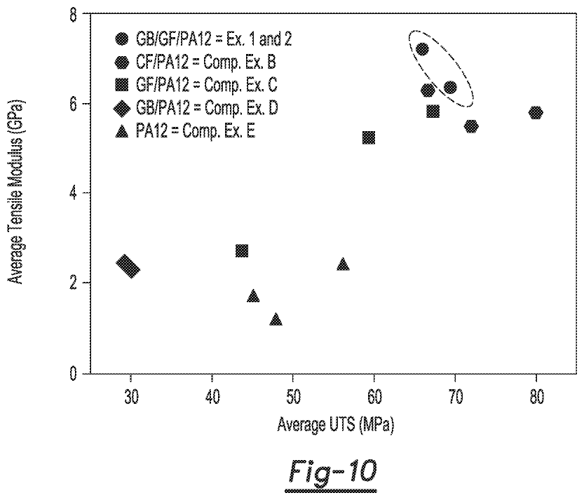

The UTS and tensile modulus were characterized as described in Example 1. The results are shown in Table 3 and FIG. 9.

TABLE 3

| | Ultimate | |
|---|---|---|
| | Tensile | Tensile |
| | Strength | Modulus |
| | (MPa) | (GPa) |
| X- | 39.98 ± 0.58 | 2.74 ± 0.15 |
| direction | | |
| Y- | 61.66 ± 2.26 | 6.01 ± 1.52 |
| direction | | |

The results for the tensile bars printed with the commercial printer were similar to, and even better than those obtained using the testbed printer. As noted herein, these results were obtained when the printer was in balanced print mode. It is believed that better mechanical properties may be obtained by altering one or more of the print mode parameters.

It was also observed that the Ex. 1 build material composition was easily spread and processed on the commercial printer.

### Example 3

To examine the effect of glass bead and glass fiber-reinforcement, the mechanical properties of the Ex. 1 and Ex. 2 tensile bars (from Example 1) were compared with data for comparative example specimens that had been printed with comparative build material compositions using selective laser sintering (SLS) or a similar fusing agent 3D printing technique described in Example 1 (referred to as “MJF”).

For the first comparison, the comparative build materials compositions were: polyamide-12 with no reinforcements (Comp. Ex. B), polyamide-12 mixed with glass beads (Comp. Ex. C), polyamide-12 mixed with glass fibers (Comp. Ex. D), and polyamide-12 mixed with carbon fibers (Comp. Ex. E). The data set forth herein for Comp. Ex. B., Comp. Ex. C, Comp. Ex. D, and Comp. Ex. E was retrieved from a variety of sources as noted in the footnote of Table 4 (data rounded to tenths place). The data is shown in both Table 4 and FIG. 10.

TABLE 4

| | Specimen ID | | | | | | | | | | |
|---|---|---|---|---|---|---|---|---|---|---|---|
| | Comp. Ex. B | | Comp. Ex. C | | Comp. Ex. D | | Comp. Ex. E | | | Ex. 1 | Ex. 2 |
| | Printing Technique | | | | | | | | | | |
| | SLS | MJF | SLS | MJF | SLS | MJF | SLS | SLS | SLS | | |
| | * | ** | *** | **** | * | ***** | ****** | ******* | ******* | MJF | MJF |
| Ultimate | 45.1 | 47.9 | 29.3 | 30.0 | 43.7 | 67.3 | 66.7 | 72 | 80 | 69.4 | 66 |
| Tensile | | | | | | | | | | | |
| Strength | | | | | | | | | | | |
| (MPa) | | | | | | | | | | | |
| Tensile | 1.72 | 1.2 | 2.4 | 2.3 | 2.71 | 5.8 | 6.3 | 5.5 | 5.8 | 6.4 | 7.2 |
| Modulus | | | | | | | | | | | |
| (GPa) | | | | | | | | | | | |

* Salazar, A., et al.; “Fatigue crack growth of SLS polyamide 12: Effect of reinforcement and temperature.” Compos. Part B: Eng. (2014) 59, 285-292;
** Sillani, F., et al.; “Selective laser sintering and multi jet fusion: Process-induced modification of the raw materials and analyses of parts performance.” Addit. Manuf. (2019) 27, 32-41;
*** Cano, A. J., et al.; “Effect of temperature on the fracture behavior of polyamide 12 and glass-filled polyamide 12 processed by selective laser sintering.” Eng. Fract. Mech. (2018) 203, 66-80;
**** O'Connor, H. J., & Dowling, D. P.; “Comparison between the properties of polyamide 12 and glass bead filled polyamide 12 using the multi jet fusion printing process.” Addit. Manuf. (2020) 31, 100961;
***** Comp. Ex. A from Example 1;
****** Jansson, A., & Pejryd, L.; “Characterisation of carbon fibre-reinforced polyamide manufactured by selective laser sintering.” Addit. Manuf. (2016) 9, 7-13;
******* Jing, W., et al.; “Surface modification of carbon fibers and the selective laser sintering of modified carbon fiber/nylon 12 composite powder.” Mat. Des. (2017) 116, 253-260.

As depicted, Ex. 1 and Ex. 2 of Example 1 exhibited higher tensile modulus over all of the SLS and MJF printed comparative build material compositions (i.e., Comp. Ex. B through Comp. Ex. E). Moreover, the UTS of Ex. 1 and Ex. 2 was comparable to those (UTS=66-80 MPa) of the SLS-printed carbon fiber reinforced 3D objects (Comp. Ex. E). Additionally, as compared with pure PA12 parts (Comp. Ex. B), Ex. 1 and Ex. 2 exhibited a maximum improvement of 45% in tensile strength and 500% in tensile modulus.

For the second comparison, the comparative build materials compositions were differently reinforced polyamide-12 compositions available from EOS, 3D systems, and HP Inc. (as identified in Table 5). The data set forth in Table 5 for these comparative build materials was retrieved from each manufacturer's technical data sheet.

TABLE 5

| Print- | | | Ultimate | | | | | |
|---|---|---|---|---|---|---|---|---|
| ing | | | Tensile | | Tensile | | Elon- | |
| Tech- | Manu- | Rein- | Strength | | Modulus | | gation | |
| nique | facturer | forcement | (MPa) | | (GPa) | | (%) | |
| SLS | EOS | glass beads | 51 | | 3.2 | | 9 | |
| | | carbon fibers & | 49 | (XY) | 3.816 | (XY) | 0.82 | |
| | | glass beads | 33 | (Z) | 1.945 | (Z) | | |
| | | aluminum | 48 | | 3.8 | | 4 | |
| | | filler | | | | | | |
| | | carbon fibers | 56 | (X) | 3.4 | (X) | 4.1 | (X) |
| | | | 72 | (Y) | 6.1 | (Y) | 6.3 | (Y) |
| | | | 25 | (Z) | 2.2 | (Z) | 1.3 | (Z) |
| | 3D | glass beads | 27 | | 4.068 | | 1.4 | |
| | Systems | | | | | | | |
| MJF | HP Inc. | glass beads | 30 | | 2.8 | | 6.5 | |
| | Ex. 1 | 5% glass | 55.04 | (X) | 3.28 | (X) | 4.56 | (X) |
| | | beads & | 69.43 | (Y) | 6.35 | (Y) | 3.71 | (Y) |
| | | 20% glass | 42.67 | (Z) | 2.69 | (Z) | 3.61 | (Z) |
| | | fibers | | | | | | |
| | Ex. 2 | 10% glass | 51.59 | (X) | 3.50 | (X) | 4.35 | (X) |
| | | beads & | 65.96 | (Y) | 7.20 | (Y) | 2.37 | (Y) |
| | | 20% glass | 36.87 | (Z) | 2.77 | (Z) | 3.49 | (Z) |
| | | fibers | | | | | | |

Ex. 1 and Ex. 2 exhibited comparable tensile strength and higher tensile modulus compared with carbon fiber reinforced 3D objects generated with SLS, and provided the highest mechanical performance among the MJF printed materials.

It is to be understood that the ranges provided herein include the stated range and any value or sub-range within the stated range, as if the value(s) or sub-range(s) within the stated range were explicitly recited. For example, a range from about 5 wt % to less than 15 wt %, should be interpreted to include not only the explicitly recited limits of from about 5 wt % to less than 15 wt %, but also to include individual values, such as about 5.15 wt %, about 6.5 wt %, 12.0 wt %, 12.77 wt %, etc., and sub-ranges, such as from about 5 wt % to about 11 wt %, from about 8 wt % to about 10 wt %, from about 10 wt % to about 15 wt %, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A three-dimensional (3D) printing build material composition, comprising:
polyamide-12 particles present in an amount of at least 55 wt % based on a total weight of the build material composition;
solid glass beads present in an amount ranging from about 5 wt % to less than 15 wt % based on the total weight of the build material composition; and
glass fibers having an average aspect ratio ranging from about 12:1 to about 20:1 and an average length ranging from about 200 μm to less than 300 μm, the glass fibers being present in an amount ranging from about 15 wt % to about 25 wt % based on the total weight of the build material composition.

2. The 3D printing build material composition as defined in claim 1, wherein:
the average length of the glass fibers ranges from about 200 μm to about 250 μm; and
an average width of the glass fibers ranges from about 12 μm to about 16 μm.

3. The 3D printing build material composition as defined in claim 2, wherein an average aspect ratio of the glass fibers is about 14:1.

4. The 3D printing build material composition as defined in claim 1, wherein each of the glass fibers has a silanized surface.

5. The 3D printing build material composition as defined in claim 1, wherein the solid glass beads have an average particle size ranging from about 20 μm to about 35 μm.

6. The 3D printing build material composition as defined in claim 1, further comprising a flow aid present in an amount up to 0.2 wt % based on the total weight of the build material composition.

7. A kit for three-dimensional (3D) printing, comprising:
a build material composition, including:
polyamide-12 particles present in an amount of at least 55 wt % based on a total weight of the build material composition;
solid glass beads present in an amount ranging from about 5 wt % to less than 15 wt % based on the total weight of the build material composition; and
glass fibers having an average aspect ratio ranging from about 12:1 to about 20:1 and an average length ranging from about 200 μm to less than 300 μm, the glass fibers being present in an amount ranging from about 15 wt % to about 25 wt % based on the total weight of the build material composition; and
a fusing agent to be applied to at least a portion of the build material composition during 3D printing, the fusing agent including an energy absorber to absorb energy to melt or fuse the build material composition in the at least the portion.

8. The kit as defined in claim 7, wherein:
the average length of the glass fibers ranges from about 200 μm to about 250 μm;
an average width of the glass fibers ranges from about 12 μm to about 16 μm; and
the solid glass beads have an average particle size ranging from about 20 μm to about 35 μm.

9. The kit as defined in claim 7, wherein an average aspect ratio of the glass fibers is about 14:1.

10. The kit as defined in claim 7, wherein each of the glass fibers has a silanized surface.

11. A three-dimensional (3D) printing method, comprising:
spreading a build material composition to form a build material layer, the build material composition including:
polyamide-12 particles present in an amount of at least 55 wt % based on a total weight of the build material composition;
solid glass beads present in an amount ranging from about 5 wt % to less than 15 wt % based on the total weight of the build material composition; and
glass fibers having an average aspect ratio ranging from about 12:1 to about 20:1 and an average length ranging from about 200 μm to less than 300 μm, the glass fibers being present in an amount ranging from about 15 wt % to about 25 wt % based on the total weight of the build material composition;
based on a 3D object model, selectively applying a fusing agent on at least a portion of the build material layer; and
exposing the build material layer to electromagnetic radiation to coalesce the build material composition in the at least the portion, thereby forming a layer of a 3D object.

12. The method as defined in claim 11, wherein prior to spreading, the method further comprises applying the build material composition to a build area platform having an X-Y plane.

13. The method as defined in claim 12, wherein:
the spreading is performed in a Y-direction of the X-Y plane; and
the selectively applying is performed in the X-direction of the X-Y plane.

14. The method as defined in claim 11, wherein
the average length of the glass fibers ranges from about 200 μm to about 250 μm;
an average width of the glass fibers ranges from about 12 μm to about 16 μm; and
the solid glass beads have an average particle size ranging from about 20 μm to about 35 μm.

15. The method as defined in claim 11, further comprising:
iteratively applying individual build material layers of the build material composition;
based on the 3D object model, selectively applying the fusing agent to at least some of the individual build material layers to define individually patterned layers; and
iteratively exposing the individually patterned layers to the electromagnetic radiation to form individual object layers.
